(19) United States
(12) Patent Application Publication
(10) Pub. No.: US 2014/0147586 A1
(43) Pub. Date: May 29, 2014

(54) PROCESS FOR MAKING AN ALKALI METAL OXYANION COMPRISING IRON

(71) Applicants: Universite de Montreal, Montreal (CA); Clariant (Canada) Inc., Toronto (CA)

(72) Inventors: Guoxian Liang, St-Bruno-de-Mondarville (CA); Dean MacNeil, Ottawa, (CA); Cheng Lifeng, Ottawa (CA)

(73) Assignees: Universite de Montreal, Montreal (CA); Clariant (Canada) Inc., Toronto (CA)

(21) Appl. No.: 14/085,144

(22) Filed: Nov. 20, 2013

Related U.S. Application Data
(60) Provisional application No. 61/730,415, filed on Nov. 27, 2012.

(51) Int. Cl. H01M 4/62; C01B 25/45

(52) U.S. Cl. CPC H01M 4/625; C01B 25/45
USPC 427/215; 423/306; 252/182.1

(57) ABSTRACT

The present invention relates to a process for making an alkali metal oxyanion comprising iron. In one aspect of the invention, hydrothermal methods are used with a nanoscale iron precursor in order to provide desirably low particle size and high purity and crystallinity.

### CROSS-REFERENCE TO RELATED APPLICATIONS

This application claims the benefit of priority to U.S. Provisional Patent Application Ser. No. 61/730,415, which is hereby incorporated herein by reference in its entirety.

### FIELD OF THE INVENTION

The present invention relates to a process for making an alkali metal oxyanion comprising iron.

### BACKGROUND

Olivine-type LiFePO₄ has recently become an important cathode material for lithium ion batteries as a result of its superior capacity retention, thermal stability, nontoxicity and safety. But olivine LiFePO₄ suffers from significant disadvantages, such as low intrinsic and ionic conductivity. Coating with carbon can improve electrical conductivity, and poor lithium ion diffusion can be addressed by the synthesis of small particles with high purity.

Hydrothermal synthesis includes the various techniques of crystallizing substances from high-temperature aqueous solutions at high vapor pressures, where synthesis of single crystals usually depends on the solubility of minerals in hot water under high pressure. U.S. Pat. No. 7,807,121 describes a process for producing cathode materials which makes use of a hydrothermal step. The process is for making cathode materials of the formula LiMPO₄, in which M represents at least one metal from the first transition series, comprising the following steps: a) production of a precursor mixture, containing at least one Li⁺ source, at least one M²⁺ source and at least one PO₄³⁻ source, in order to form a precipitate and thereby to produce a precursor suspension; b) dispersing or milling treatment of the precursor mixture and/or the precursor suspension until the D90 value of the particles in the precursor suspension is less than 50 μm; and c) the obtaining of LiMPO₄ from the precursor suspension obtained in accordance with b), preferably by reaction under hydrothermal conditions. When the M²⁺ source comprises Fe²⁺, the relatively high cost of such precursor may however, in some instances, raise commercial barriers to the industrial implementation of the process.

Problems therefore remain to find a simple and cost-effective process for making cathode materials for battery applications.

### SUMMARY OF INVENTION

In one non-limiting broad aspect, the present invention relates to a process for manufacturing an alkali metal oxyanion, where the metal comprises Fe. The process comprises the steps of (i) providing a source of Fe having a nanoscale size (<1.0 μm) and (ii) a hydrothermal treatment on a mixture of the source of Fe having a nanoscale size and of the other precursors of the alkali metal oxyanion for manufacturing the alkali metal oxyanion.

In another non-limiting broad aspect, the present invention relates to a process for manufacturing an alkali metal oxyanion, wherein the metal comprises Fe. The process comprising the steps of (i) wet-nanomilling a source of Fe to obtain nanoscale particles having a size of less than 1.0 μm and (ii) a hydrothermal treatment on a mixture of the source of Fe having a nanoscale size and of the other precursors of the alkali metal oxyanion for manufacturing the alkali metal oxyanion.

These and other aspects and features of the present invention will now become apparent to those of ordinary skill in the art upon review of the following detailed description of embodiments.

### BRIEF DESCRIPTION OF THE DRAWINGS

FIG. 1 is a flowchart of a process according to one embodiment of the invention;

FIG. 2 is a graph of XRD patterns of LiFePO₄(OH) synthesized with and without citric acid by a hydrothermal method (trace a and b respectively), as described Example 9; and of XRD patterns of C—LiFePO₄ synthesized with and without citric acid by a hydrothermal method (trace c and d respectively), as described Example 9;

FIG. 3 is a set of SEM images of as-synthesized LiFePO₄(OH) (a, b) and the corresponding C—LiFePO₄ (c, d), as described in Example 9.

FIG. 4 are graphs of electrochemical properties of the C—LiFePO₄ samples synthesized with and without citric acid as described in Example 9.

FIGS. 5A and 5B are a set of XRD spectra of LiFePO₄(OH) and C—LiFePO₄ materials made at different temperatures as described in Example 9;

FIG. 6 is a set of graphs demonstrating electrochemical performance of the C—LiFePO₄ made at different temperatures as described in Example 9;

FIG. 7A is an SEM image of the milled Fe₂O₃ as described in Example 9;

FIGS. 7B and 7C respectively are an image of the morphology of, and the specific discharge capacity of the C—LiFePO₄ prepared with the milled Fe₂O₃ as described in Example 9;

FIG. 8 is an XRD pattern of the product of the first preparation Example 10 (trace a); and an XRD pattern of the product of the third preparation of Example 10 (trace b).

FIG. 9 is an XRD pattern of the product of the second preparation of Example 10 (trace a); an XRD pattern of a product prepared with ascorbic acid alone as the reducing agent as described in Example 10 (trace b); and an XRD pattern of a product prepared with ascorbic acid and H₃PO₃ as reducing agents as described in Example 10 (trace c).

FIGS. 10A-10D are a set of XPS spectra for the product prepared with ascorbic acid and H₃PO₃ as reducing agents as described in Example 10;

FIG. 11 is a set of XRD patterns for a set of materials prepared at different reaction times as described in Example 10;

FIGS. 12A-12F are a series of SEM images of materials prepared at different reaction times as described in Example 10;

FIGS. 13A and 13B are XRD patterns of LiMn_{0.7}Fe_{0.3}PO₄ as described in Example 11;

FIGS. 14A and 14B are SEM images of LiMn_{0.7}Fe_{0.3}PO₄ materials prepared as described in Example 11;

FIG. 15 is an initial charge-discharge curve of the C—LiMn_{0.7}Fe_{0.3}PO₄ as described in Example 11;

FIG. 16 is a graph of the results of cycling tests of the C—LiMn_{0.7}Fe_{0.3}PO₄ as described in Example 11;

FIG. 17 provides XRD patterns of LiMn_{0.7}Fe_{0.3}PO₄ as described in Example 11; and

FIGS. 18A and 18B are SEM images of materials prepared by solid state synthesis as described in Comparative Example 2.

### DETAILED DESCRIPTION OF EMBODIMENTS

The present disclosure affords the person skilled in the art with a process for making an alkali metal oxyanion, where the metal comprises Fe. It has been surprising and unexpectedly discovered that providing a source of Fe having a nanoscale size (<1.0 μm) simplifies and reduces costs associated with an industrial implementation of a process for manufacturing an alkali metal oxyanion (i.e., a material that includes an alkali species, a metal species, and an oxyanion species), where the metal comprises Fe, where the process includes a hydrothermal step. For example, one may provide a source of Fe that is commercially available and having a nanoscale size. Advantageously, one may provide a source of Fe that is commercially available at a microscale size and implement, prior to the hydrothermal step, a wet-nanomilling step in order to obtain a source of Fe at the nanoscale size.

As used herein, particles of nanoscale size have an average particle size of less than 1.0 μm. In certain embodiments, materials of nanoscale size have a D90 less than 1.0 μm.

In one non-limiting embodiment, the herein described wet-nanomilling step includes nanomilling at least a portion of the precursors or all the precursors.

In one non-limiting implementation of the invention, the process for manufacturing an alkali metal oxyanion, wherein the metal comprises Fe, comprises accordingly the steps of (i) wet-nanomilling a source of Fe to obtain nanoscale particles having a size of less than 1.0 μm and (ii) a hydrothermal treatment of a mixture of the source of Fe having a nanoscale size and of the other precursors of the alkali metal oxyanion for manufacturing the alkali metal oxyanion.

As used herein, “nanomilling” means a step of milling a compound in order to obtain particles of the compound having a nanoscale size in the order to less than 1 μm.

As used herein, “wet-nanomilling” means performing the nanomilling step in a suitable solvent, in particular a polar solvent. Non-limiting examples of suitable solvent include, but are not limited thereto, water, methanol, ethanol, 2-propanol, ethylene glycol, propylene glycol, acetone, cyclohexanone, 2-methyl pyrollidone, ethyl methyl ketone, 2-ethoxyethanol, propylene carbonate, ethylene carbonate, dimethyl carbonate, dimethyl formamide or dimethyl sulphoxide or mixtures thereof.

Water is a preferred solvent. In addition to water, further solvents that are miscible with water can also be present. Examples of these solvents are aliphatic alcohols having 1 to 10 carbon atoms like methanol, ethanol, propanols, for example n-propanol or iso-propanol, butanols, for example n-butanol, iso-butanol.

The person skilled in the art will be able to select any suitable solvent without undue effort. In one non-limiting embodiment, the source of Fe comprises Fe³⁺, or Fe⁺², or a Fe+²/Fe+³ mixture, or a Fe°/Fe⁺³ mixture, or any combinations thereof. Preferably, the source of Fe comprises Fe³⁺. For example, in one non-limiting embodiment, the source of Fe provides Fe substantially in the form of Fe(III). In another non-limiting embodiment, the source of Fe provides Fe in the form of a mixture of Fe(II) and Fe(III).

In a non-limiting embodiment, the alkali metal oxyanion has the general nominal formula AₐMₘ(XO₄)ₓZ_{z} in which:
A is an alkali metal selected from lithium, sodium, potassium and any combinations thereof, and 0<a≦8;
M comprise at least 50% at. of Fe, or Mn, or a mixture thereof, and 1≦m≦3; and
XO₄ is an oxyanion in which X is selected from P, S, V, Si, Nb, Mo and any combinations thereof; and 0<x≦3; and
Z is an hydroxide; and 0≦z≦3, and
   wherein A, M, X, Z, a, m, x and z are selected as to maintain electroneutrality of said compound.

In another non-limiting embodiment, the alkali metal oxyanion has the general nominal formula AₐMₘ(XO₄)ₓZ_{z} in which:
A is an alkali metal selected from lithium, sodium, potassium and any combinations thereof, and 0<a≦8;
M is selected from the group consisting of Fe, Mn, and mixture thereof, alone or partially replaced by at most 50% as atoms of one or more other metals selected from Ni and Co, and/or by at most 20% as atoms of one or more aliovalent or isovalent metals other than Ni or Co, and 1≦m≦3; and
XO₄ is an oxyanion in which X is selected from P, S, V, Si, Nb, Mo and any combinations thereof; and 0<x≦3; and
Z is an hydroxide; and 0≦z≦3, and
   wherein A, M, X, Z, a, m, x and z are selected as to maintain electroneutrality of said compound.

In yet another non-limiting embodiment, the alkali metal oxyanion has the general nominal formula AₐMₘ(XO₄)ₓZ_{z} in which:
A is an alkali metal selected from lithium, sodium, potassium and any combinations thereof, and 0<a≦8;
M is selected from the group consisting of Fe, Mn, and mixture thereof, alone or partially replaced by at most 50% as atoms of one or more other metals chosen from Ni and Co, and/or by at most 15% as atoms of one or more aliovalent or isovalent metals selected from the group consisting of Mg, Mo, Nb, Ti, Al, Ta, Ge, La, Y, Yb, Cu, Sm, Sn, Pb, Ag, V, Ce, Hf, Cr, Zr, Bi, Zn, Ca, B; and 1≦m≦3; and
XO₄ is an oxyanion in which X is selected from P, S, V, Si, Nb, Mo and any combinations thereof; and 0<x≦3; and
Z is an hydroxide; and 0≦z≦3, and
   wherein A, M, X, Z, a, m, x and z are selected as to maintain electroneutrality of said compound.

In yet a further non-limiting embodiment, the alkali metal oxyanion has the general nominal formula AₐMₘ(XO₄)ₓZ_{z} in which:
1. A is an alkali metal selected from lithium, sodium, potassium and any combinations thereof, and 0<a≦8;
   M is selected from the group consisting of Fe, Mn, and mixture thereof, alone or partially replaced by at most 10% as atoms of one or more other metals chosen from Ni and Co, and/or by at most 10% as atoms of one or more aliovalent or isovalent metals selected from the group consisting of Mg, Mo, Nb, Ti, Al, Ta, Ge, La, Y, Yb, Cu, Sm, Sn, Pb, Ag, V, Ce, Hf, Cr, Zr, Bi, Zn, Ca, B and W; and 1≦m≦3; and
   XO₄ is an oxyanion in which X is selected from P, S, V, Si, Nb, Mo and any combinations thereof; and 0<x≦3; and
   Z is an hydroxide; and 0≦z≦3, and
      wherein A, M, X, Z, a, m, x and z are selected as to maintain electroneutrality of said compound.

In yet a further non-limiting embodiment, the alkali metal oxyanion has the general nominal formula AₐMₘ(XO₄)ₓZ_{z} in which:
A represents Li, alone or partially replaced by at most 20% as atoms of Na and/or K, and 0<a≦8;
M comprise at least 80% at. of Fe, or Mn, or a mixture thereof, and 1≦m≦3; and
XO₄ represents PO₄, alone or partially replaced by at most 30 mol % of SO₄ or SiO₄, and 0<x≦3; and
Z is an hydroxide; and 0≦z≦3, and
wherein A, M, X, Z, a, m, x and z are selected as to maintain electroneutrality of said compound.

In yet a further non-limiting embodiment, the alkali metal oxyanion has the general nominal formula AM(XO₄)Z_{z} in which:
A represents Li, alone or partially replaced by at most 20% as atoms of Na and/or K;
M comprise at least 80% at. of Fe, or Mn, or a mixture thereof; and
XO₄ represents PO₄, alone or partially replaced by at most 30 mol % of SO₄ or SiO₄; and
Z is an hydroxide; and 0≦z≦1, and
wherein A, M, X, Z and z are selected as to maintain electroneutrality of said compound.

In another yet non-limiting embodiment, the alkali metal oxyanion has the general nominal formula LiMPO₄Z_{z}, Z is an hydroxide and 0≦z≦1, and M comprising at least 50% at., preferably at least 80% at., more preferably at least 90% at. of Fe, or Mn, or a mixture thereof.

In certain embodiments, it can be desirable to provide the starting materials such that the ratio of A, M and X atoms is substantially the same as in the desired product. For example, when the desired material is AₐMₘ(XO4)ₓ, it can be desirable to provide the starting materials in a molar ratio of about a:x:m (e.g., within 10%, within 5%, or even within 1%). When the desired material is LiMn_{y}Fe_{1-y}PO₄, it can be desirable to provide the starting materials in a molar ratio of about 1:y:(1−y):1 (e.g., within 10%, within 5%, or even within 1%). When the desired material is LiFePO₄, it can be desirable to provide the starting materials in a molar ratio of about 1:1:1 (e.g., within 10%, within 5%, or even within 1%).

In a non-limiting embodiment, the herein described alkali metal oxyanion comprises sulfates, phosphates, silicates, oxysulfates, oxyphosphates, oxysilicates and mixtures thereof, of a transition metal and lithium, and mixtures thereof.

In general, the process and material of the invention can be used to manufacture most of transition metal phosphate-based electrode materials contemplated in previous patent and applications such as described without limitation in U.S. Pat. No. 5,910,382, U.S. Pat. No. 6,514,640, U.S. Pat. No. 6,391,493, EP 0 931 361, EP 1 339 119, and WO 2003/069701.

In one non-limiting embodiment, the precursors described herein comprises a mixture of chemicals containing most or all elements required and selected to react chemically in order to obtain the at least partially lithiated metal oxyanion described herein. Preferably the precursors are of low cost, largely available commodity materials or naturally occurring chemicals. In one non-limiting embodiment, the herein described precursors comprise in the case of LiFePO₄ as the desired end-compound: iron, iron oxides, phosphate minerals and commodity lithium or phosphate chemicals such as: Li₂CO₃, LiOH, P₂O₅, H₃PO₄, ammonium or lithium hydrogenated phosphates. Carbonaceous additive, gases or simply thermal conditions can be used to control the redox transition metal oxidation level in the end-product.

In one non-limiting embodiment, the precursors described herein comprises an alkali source selected, for example, from the group consisting of lithium oxide, sodium oxide, lithium hydroxide, sodium hydroxide, potassium hydroxide, lithium carbonate, sodium carbonate, potassium carbonate, Li₃PO₄, Na₃PO₄, K₃PO₄, LiH₂PO₄, LiNaHPO₄, LiKHPO₄, NaH₂PO₄, KH₂PO₄, Li₂HPO₄, lithium, sodium or potassium ortho-, meta- or polysilicates, lithium sulfate, sodium sulfate, potassium sulfate, lithium oxalate, sodium oxalate, potassium oxalate, lithium acetate, sodium acetate, potassium acetate and one of their mixtures. The person skilled in the art will be able to select any suitable alkali source without undue effort.

In one non-limiting embodiment, the precursors described herein comprises a metal source comprises a compound selected, for example, from iron, iron(III) oxide or magnetite, trivalent iron phosphate, lithium iron hydroxyphosphate or trivalent iron nitrate, ferrous phosphate, hydrated or nonhydrated, vivianite Fe₃(PO₄)₂, iron acetate (CH₃COO)₂Fe, iron sulfate (FeSO₄), iron oxalate, iron(III) nitrate, iron(II) nitrate, FeCl₃, FeCl₂, FeO, ammonium iron phosphate (NH₄FePO₄), Fe₂P₂O₇, ferrocene or one of their mixtures; and/or manganese, MnO, MnO₂, manganese acetate, manganese oxalate, Mn(III) acetylacetonate, Mn(II) acetylacetonate, Mn(II) chloride, MnCO₃, manganese sulfate, manganese nitrate, manganese phosphate, manganocene or one of their mixtures. The person skilled in the art will be able to select any suitable metal source compound without undue effort.

In one non-limiting embodiment, the herein described metal source comprises an Fe(III) compound. In general, any iron-comprising compounds in which iron has the oxidation state +3, known to a person having ordinary skill in the art can be used in the process described herein. As such, a single iron-comprising compound in which iron has the oxidation state +3, or a mixture of different iron-comprising compounds in which iron has the oxidation state +3 can be used in the process herein described. It is also possible to use an iron-comprising compound in which both iron in oxidation state +2 and +3 are present, for example but without being limited thereto, Fe₃O₄. It is also possible to use a mixture of different iron-comprising compounds comprising a compound in which iron has the oxidation state +3 and another compound in which iron has the oxidation state +2. It is also possible to use a mixture of different iron-comprising compounds comprising a compound in which iron has the oxidation state +3 and another compound in which iron is metallic iron.

In one non-limiting embodiment, the iron-comprising compound in which iron has the oxidation state +3 is chosen from the group consisting of iron(II,III)-oxide, iron(III)-oxide, iron(III)-oxide hydroxide, or iron(III)-hydroxide, for example Fe₃O₄, alpha-Fe₂O₃, gamma-Fe₂O₃, alpha-FeOOH, beta-FeOOH, gamma-FeOOH and Fe(OH)₃.

In another non-limiting embodiment, at least one reducing agent is added to the mixture concomitant to the nanomilling step or to the hydrothermal step or both steps. The reducing agent may be carbon-free or may contain carbon, or could be a metallic reducing compound, such as Fe⁰.

In one non-limiting embodiment, the herein described at least one reducing agent is chosen from hydrazine or derivatives thereof, hydroxyl amine or derivatives thereof, reducing sugars, such as glucose, saccharose (sucrose) and/or lactose, alcohols, such as aliphatic alcohols having 1 to 10 carbon atoms, methanol, ethanol, propanols, for example n-propanol or isopropanol, butanols, for example n-butanol, iso-butanol, ascorbic acid, citric acid, sulfite, oxalic acid, formic acid compounds comprising easily oxidisable double bonds, and any mixtures thereof.

In a preferred embodiment, the herein described at least one reducing agent is ascorbic or citric acid.

Non-limiting examples of derivatives of hydrazine are hydrazine-hydrate, hydrazine-sulfate, hydrazine-dihydrochlorid and others. An example of a derivative of hydroxyl amine is hydroxyl amine-hydrochloride. Particularly preferred carbon-free reducing agents are hydrazine, hydrazine-hydrate, hydroxyl amine or mixtures thereof.

It is noted that the at least one reducing agent described herein can be selected without undue effort by the person skilled in the art based on the teaching described herein.

In certain embodiments, however, citric acid is not used as a reducing agent, but rather as a chelating agent. As described in more detail in the Examples below, use of a chelating agent can provide desirable particle sizes to the ultimate material.

In one non-limiting embodiment, the herein described process further comprises steps for controlling the particle size and distribution, for example, by using any of the known technique in the art, such as, but without being limited thereto, crushing, grinding, jet milling/classifying/mechanofusion. Typical particle or agglomerate sizes that are available to one skilled in the art may range between hundredth or tenth of a micron to several microns.

The herein described “hydrothermal treatment” per se can be carried out in a manner known and familiar to the person skilled in the art without undue effort. In one non-limiting embodiment, the temperature used for the hydrothermal treatment may be selected from within the range between about 100 to about 250° C., in particular from 100 to 180° C. and a pressure used for the hydrothermal treatment may be selected from 1 bar to 40 bar, in particular from 1 bar to 10 bar steam pressure. One example of a possible hydrothermal process is described in JP 2002-151082. In this case, according to one embodiment, the precursor mixture is reacted in a tightly closed or pressure-resistant vessel. The reaction preferably takes place in an inert or protective gas atmosphere. Examples of suitable inert gases include nitrogen, argon, carbon dioxide, carbon monoxide or any mixtures thereof. The hydrothermal treatment may, for example, be carried out for 0.5 to 15 hours, in particular for 3 to 11 hours. Purely as a non-limiting example, the following specific conditions may be selected: 1.5 h heat-up time from about 50° C. (temperature of the precursor mixture) to about 160° C., 10 h hydrothermal treatment at about 160° C., 3 h cooling from about 160° C. to 30° C.

It is noted that the experimental conditions at which the hydrothermal treatment is performed can be selected without undue effort by the person skilled in the art based on the teaching described herein.

In one non-limiting embodiment, the mean particle size of the Fe source used in the hydrothermal treatment is less than about 600 nm, preferably less than about 400 nm, and most preferably less than about 200 nm. The device for performing the herein described nanomilling step may be selected from any bead mills that can reduce the particles size down to the nanometer range. Particularly, mention may be made of the Ultra APEX™ Mill by Kotobuki Industries Co. Ltd of Japan, High speed Netzsch Zeta™ agitator bead mill by Netzsch of Germany, Hosokawa Alpine AHM™ mill by Hosokawa of Japan, and MicroMedia(R)™ P1 & MicroMedia(R)™ P2 bead mill by Buehler of Switzerland. The grinding beads may be made of alumina, zirconia or carbides for example.

It is noted that the device for performing the herein described nanomilling step can be selected without undue effort by the person skilled in the art based on the teaching described herein.

In one non-limiting embodiment, AₐMₘ(XO₄)ₓZ_{z} obtained after hydrothermal treatment is subject to a further grinding step to modify its particle size distribution. Non-limiting examples of the further grinding step include, but without being limited thereto, jet milling, wet and dry milling (planetary ball mill, etc. . . . ), nanomilling, and the like.

In one non-limiting embodiment, the slurry after the hydrothermal step or after the wet-nanomilling step is subjected to a spray drying, optionally in the presence of an organic carbon precursor, to obtain a compound of formula AₐMₘ(XO₄)ₓZ_{z} in the form of micrometer-sized secondary particles, each of which is composed of crystalline nanometer-sized primary particles of AₐMₘ(XO₄)ₓZ_{z}.

In one non-limiting embodiment, the micrometer-sized secondary particles have a particle size ranging from about 1 to about 50 μm. In one non-limiting embodiment, each of the micrometer-sized secondary particles is composed of crystalline nanometer-sized primary particles of a metal compound having a particle size ranging from about 10 to about 500 nm.

The expression “nominal formula” is used herein to mean that the stoichiometry of the material can vary by a few percents from stoichiometry due to substitution or other defects present in the structure, including anti-sites structural defects such as, without any limitation, cation disorder between iron and lithium in LiFePO₄ crystal, see for example Maier et al. [Defect Chemistry of LiFePO₄, Journal of the Electrochemical Society, 155, 4, A339-A344, 2008] et Nazar et al. [Proof of Supervalent Doping in Olivine LiFePO₄, Chemistry of Materials, 2008, 20 (20), 6313-6315]. Unless otherwise specified, the chemical formulae used herein are presented as nominal formulae.

The deposit of carbon can be present as a more or less uniform, adherent and non-powdery deposit. It represents up to 15% by weight, preferably from 0.5 to 5% by weight, with respect to the total weight of the material. The deposit of carbon is obtained, for example, by pyrolysis of an organic source during the synthesis or after the synthesis of the herein described at least partially lithiated metal oxyanion as described for example in U.S. Pat. No. 6,855,273, U.S. Pat. No. 6,962,666, WO 2002/27824 and WO 2002/27823, or by mechanofusion in the presence of particles of carbon powder as described for example in U.S. Pat. No. 5,789,114 and WO 2004/008560. In one non-limiting embodiment, the pyrolysis is performed during the herein described hydrothermal step. In another non-limiting embodiment, an optional flash pyrolysis is performed after the synthesis reaction to improve carbon deposit graphitization. In another non-limiting embodiment, the herein described said organic source of carbon is present during the nanomilling step.

In one non-limiting embodiment, the herein described carbon-deposited alkali metal oxyanion material may be composed of individual particles and/or agglomerates of individual particles. The size of the individual particles is preferably between 10 nm and 3 μm. The size of the agglomerates is preferably between 100 nm and 30 μm.

In one non-limiting embodiment, the carbon-deposited alkali metal oxyanion material is composed of agglomerates (also known as “secondary particles”) with a 0.5 μm≦D₅₀ 10 μM.

In one non-limiting embodiment, the carbon-deposited alkali metal oxyanion material is composed of secondary particles with a D₉₀≦30 μm.

In one non-limiting embodiment, the carbon-deposited alkali metal oxyanion is in particulate form or agglomerate of nanoscaled particles, and the deposit of carbon on C-AₐMₘ(XO₄)ₓZ_{z} is deposited on the surface of the particles or inside agglomerate of the nanoscaled particles.

In a specific non-limiting embodiment, when we refer herein to the cathode material being used as cathode in a lithium battery, the lithium battery can be, for example but without being limited thereto, a solid electrolyte battery in which the electrolyte can be a plasticized or non-plasticized polymer electrolyte, a battery in which a liquid electrolyte is supported by a porous separator, or a battery in which the electrolyte is a gel.

Accordingly, one non-limiting embodiment of a method as described herein is a method for manufacturing an alkali metal oxyanion having the nominal formula LiₐFe_{b}Mn_{c}Mₘ(PO₄)ₓ(OH)_{z} in which:
2.—0.8≦a≦1.2;
   0.2≦b≦1
   0≦c≦0.8
   M is selected from the group consisting of Mg, Mo, Nb, Ti, Al, Ta, Ge, La, Y, Yb, Cu, Sm, Sn, Pb, Ag, V, Ce, Hf, Cr, Zr, Bi, Zn, Ca, B and W;
   0≦m≦0.1;
   b+c+m=1
   0.8<x≦1.2; and
   0≦z≦0.2,
      the method comprising:
   providing a source of Fe having nanoscale size, optionally a source of Mn having nanoscale size, and optionally a source of M having a nanoscale size; and
   subjecting the source of Fe, if provided, the source of Mn, and, if provided, the source of M to hydrothermal treatment with lithium phosphate, lithium hydrogen phosphate, lithium dihydrogen phosphate, or lithium hydroxide in combination with phosphoric acid, or a mixture thereof.

In certain such embodiments as described above, m is 0, z is 0, or both m and z are 0.

The source of Fe and the source of Mn can be as described above. For example. in certain embodiments, the source of Fe is Fe₂O₃; and the source of Mn is MnO.

In certain such embodiments, the hydrothermal reaction itself forms an intermediate in which the Fe is provided as Fe(III). In such embodiments, a separate reduction step can be performed to reduce the Fe(III) to provide Fe(III). For example, in one embodiment, the hydrothermal reaction product can be calcined with an organic compound (e.g., a reducing sugar, such as glucose, saccharose (sucrose) and/or lactose) to provide Fe(III). The calcination step can also provide a carbon coating on the crystalline material. In other embodiments, a carbon coating can be provided in a separate step using methods known to the person of ordinary skill in the art.

Another non-limiting embodiment of a method as described herein is a method for manufacturing an alkali metal oxyanion having the nominal formula LiMn_{y}Fe_{1-y}PO₄ in which 0≦y≦0.8, the method comprising:
providing a source of Fe having nanoscale size, and, optionally, a source of Mn having nanoscale size; and
   subjecting the source of Fe and, if provided, the source of Mn to hydrothermal treatment with lithium phosphate, lithium hydrogen phosphate, lithium dihydrogen phosphate, or lithium hydroxide in combination with phosphoric acid, or a mixture thereof, under conditions sufficient to form LiMn_{y}Fe_{1-y}PO₄(OH); and
   reducing the LiMn_{y}Fe_{1-y}PO₄(OH) to form LiMn_{y}Fe_{1-y}PO₄.

In certain such embodiments, the hydrothermal treatment can be performed in the presence of a chelating agent, for example, citric acid. As described below in more detail in the Examples, a chelating agent such as citric acid can help to provide homogeneous particle distribution. When a chelating agent is used, it can be present, for example, in a molar ratio to the Fe source in the range of 0.2:1 to 5:1, e.g., 0.5:1 to 2:1.

In certain embodiments, the lithium compound used is lithium dihydrogen phosphate. In other embodiments, lithium is provided as lithium hydroxide in combination with phosphoric acid.

In certain embodiments, the person of ordinary skill in the art will select amounts of compounds to provide the desired stoichiometry to the final product. For example, when the desired product is LiFePO₄, the person of skill in the art can use amounts of lithium compound, iron compound and phosphate to yield a 1:1:1 Li:Fe:P ratio.

As the person of ordinary skill in the art will appreciate, the hydrothermal treatment can be performed at a variety of temperatures and for a variety of times. The hydrothermal treatment can be performed, for example, by autoclaving at a temperature in the range of about 200° C. to about 250° C. (e.g., about 220° C.). The reaction can proceed, for example, for at least about 6 hours, at least about 8 hours, or even at least about 10 hours. In other embodiments, the reaction can proceed for at least about 20 hours, at least about 30 hours, or even at least about 40 hours. The person of ordinary skill in the art will determine hydrothermal conditions in accordance with the present disclosure.

In certain embodiments, the reduction step can be performed by calcining the LiMn_{y}Fe_{1-y}PO₄(OH) with an organic compound such as a reducing sugar (e.g., glucose, saccharose (sucrose) and/or lactose) to convert the LiMn_{y}Fe_{1-y}PO₄(OH) to LiMn_{y}Fe_{1-y}PO₄ by reduction of Fe(III) to Fe(II). In certain such embodiments, the calcination can also provide a carbon coating on the crystalline LiMn_{y}Fe_{1-y}PO₄. The person or ordinary skill in the art will determine the appropriate calcination temperature in accordance with the guidance provided below in the Examples. In certain such embodiments, the calcination is performed at a temperature in the range of about 600° C. to about 800° C. (e.g., in the range of about 650° C. to about 750° C.). The calcination can be performed under an inert atmosphere, e.g., under nitrogen. The calcination can be performed, for example, for a time in the range of about 1 h to about 10 h.

In certain embodiments, the value of y is 0 (i.e., the material to be made is LiFeFO₄. In other embodiments, the value of y is in the range of 0.5 to 0.8, e.g., 0.7 (i.e., the material to be made is LiMn_{0.7}Fe_{0.3}PO₄).

The person of ordinary skill in the art can adapt such methods as otherwise described herein, for example, as described with reference to the Examples.

Another non-limiting embodiment of a method as described herein is a method for manufacturing an alkali metal oxyanion having the nominal formula LiMn_{y}Fe_{1-y}PO₄ in which 0≦y≦0.8, the method comprising:
providing a source of Fe having nanoscale size, and, optionally, a source of Mn having nanoscale size; and
subjecting the source of Fe and, if provided, the source of Mn to hydrothermal treatment with lithium phosphate, lithium hydrogen phosphate, lithium dihydrogen phosphate or a mixture thereof and one or more reducing agents, under conditions sufficient to form LiMn_{y}Fe_{1-y}PO₄.

In certain embodiments, the lithium compound used is lithium dihydrogen phosphate. In other embodiments, lithium is provided as lithium hydroxide in combination with phosphoric acid.

In certain embodiments, the person of ordinary skill in the art will select amounts of compounds to provide the desired stoichiometry to the final product. For example, when the desired product is LiFePO₄, the person of skill in the art can use amounts of lithium compound, iron compound and phosphate to yield a 1:1:1 Li:Fe:P ratio.

As described above, a variety of reducing agents can be used in practicing such methods. For example, in certain embodiments, the reducing agent is ascorbic acid. In other such embodiments, the reducing agent is H₃PO₃. In still other such embodiments, the reducing agent is a combination of ascorbic acid and H₃PO₃, The person of oridinary skill in the art can select the appropriate amount of reducing agent to provide the desired product. For example, the reducing agent(s) can be used in a molar ratio to Fe in the range of about 1:1 to about 2:1, e.g., about 1:1 to about 1.1:1, or even about 1:1.

As the person of ordinary skill in the art will appreciate, the hydrothermal treatment can be performed at a variety of temperatures and for a variety of times. The hydrothermal treatment can be performed, for example, by autoclaving at a temperature in the range of about 200° C. to about 250° C. (e.g., about 220° C.). The reaction can proceed, for example, for at least about 6 hours, at least about 8 hours, or even at least about 10 hours. In other embodiments, the reaction can proceed for at least about 20 hours, at least about 30 hours, or even at least about 40 hours. The person of ordinary skill in the art will determine hydrothermal conditions in accordance with the present disclosure.

In certain such embodiments, the hydrothermal treatment can be performed in the presence of a chelating agent, for example, citric acid. As described below in more detail in the Examples, a chelating agent such as citric acid can help to provide homogeneous particle distribution. When a chelating agent is used, it can be present, for example, in a molar ratio to the Fe source in the range of 0.2:1 to 5:1, e.g., 0.5:1 to 2:1.

In certain embodiments, use of a carbonaceous reducing agent can provide for carbon-coated crystalline material in the hydrothermal step. In other embodiments (e.g., when H₃PO₃ is used as the reducing agent), a separate carbon coating step can be used. The procedures described herein can be used for carbon coating such materials. Otherwise, the person of ordinary skill in the art can use other carbon coating methods. For example, the, carbon coating step can be performed by calcining the LiMnₓFe₁₋ₓPO₄(OH) with an organic compound such as a reducing sugar (e.g., glucose, saccharose (sucrose) and/or lactose) to convert the LiMn_{y}Fe_{1-y}PO₄(OH) to LiMn_{y}Fe_{1-y}PO₄ by reduction of Fe(III) to Fe(II). In certain such embodiments, the calcination can also provide a carbon coating on the crystalline LiMn_{y}Fe_{1-y}PO₄. The person or ordinary skill in the art will determine the appropriate calcination temperature in accordance with the guidance provided below in the Examples. In certain such embodiments, the calcination is performed at a temperature in the range of about 600° C. to about 800° C. (e.g., in the range of about 650° C. to about 750° C.). The calcination can be performed under an inert atmosphere, e.g., under nitrogen. The calcination can be performed, for example, for a time in the range of about 1 h to about 10 h.

In certain embodiments, the value of y is 0 (i.e., the material to be made is LiFePO₄. In other embodiments, the value of y is in the range of 0.5 to 0.8, e.g., 0.7 (i.e., the material to be made is LiMn_{0.7}Fe_{0.3}PO₄).

Details of the invention will be further described in the following illustrative and non-limiting embodiment examples.

### Comparative Example 1

### Synthesis of C—LiFePO₄

LiH₂PO₄ (sold by Sigma-Aldrich), micron-sized Fe₂O₃ (5 μm, sold by Sigma-Aldrich) and citric acid, with a 1:0.5:1 molar ratio, were charged in a 40 ml Teflon liner containing water. After purging water with N₂ under sonification, the liner was put into a stainless steel autoclave. Subsequently, the autoclave was put into an oven (Isotemp, sold by Fisher Scientific) and maintained at 220° C. for 12 hours to perform a hydrothermal treatment. After cooling, the slurry was dried at 80° C. under continuous stirring to evaporate the solvent.

The as-prepared compound was then mixed in water with 15 wt. % β-lactose (sold by Sigma-Aldrich) to prepare a uniform slurry, followed by drying at 80° C. for 3 hours.

In an airtight container with a gas inlet and outlet, the as-prepared compound/β-lactose mixture in a ceramic crucible was heated up to 700° C. and maintained at that temperature for about two hours in a furnace. The airtight container was maintained under flushing with dry nitrogen (100 ml/mn) throughout the duration of the heat treatment. After cooling, the end-product named LMP-1 and was obtained in the form of a black powder.

### Example 1

### Synthesis of C—LiFePO₄

Micron-sized Fe₂O₃ (5 μm, sold by Sigma-Aldrich) was nanomilled in water with a continuous-flow agitator bead mill (MicroCer, sold by Netzsch) in order to obtain to obtain nanomilled Fe₂O₃ having a nanoscale particle size in the order of about 100 nm.

LiH₂PO₄ (sold by Sigma-Aldrich), nanomilled Fe₂O₃ and citric acid, with 1:0.5:1 molar ratio, were charged in a 40 ml Teflon liner containing water. After purging water with N₂ under sonification, the liner was put into a stainless steel autoclave. Subsequently, the autoclave was put into an oven (Isotemp, sold by Fisher Scientific) and maintained at 220° C. for 12 hours to perform a hydrothermal treatment. After cooling, the slurry was dried at 80° C. under continuous stirring to evaporate the solvent. The resulting compound was LiFePO₄(OH).

An identical experiment was repeated, except for replacing citric acid with ascorbic acid. The resulting compound thus obtained was LiFePO₄.

Each of the as-prepared compound was mixed in water with 15 wt. % β-lactose (sold by Sigma-Aldrich) to prepare a uniform slurry, followed by drying at 80° C. for 3 hours.

In an airtight container with a gas inlet and outlet, each of the as-prepared compound/β-lactose mixture in a ceramic crucible was heated up to 700° C. and maintained at that temperature for about two hours. The airtight container was maintained under flushing with dry nitrogen (100 ml/mn) throughout the duration of the heat treatment. After cooling, the end-compound, carbon deposited LiFePO₄, was obtained in the form of a black powder (the end-compound was named LMP-2 in the case where we used citric acid, and LMP-3 in the case where we used ascorbic acid).

### Example 2

### Synthesis of C—LiFePO₄

LiOH.H₂O (sold by Rockwood Lithium), H₃PO₄ (85 wt. % in H₂O, sold by Sigma-Aldrich), micron-sized Fe₂O₃ (5 μm, sold by Sigma-Aldrich), with 1:1:0.5 molar ratio, were nanomilled in water using a continuous-flow agitator bead mill (MicroCer, sold by Netzsch) in order to obtain a nanomilled slurry having nanoscale particles. The nanomilled slurry was then placed in a high pressure reactor (Series 4540, sold by Parr Instrument Company) containing water. 6-7 bar of nitrogen was applied to the autoclave via the immersion pipe and then this pressure was relieved again via the relief valve. The procedure was repeated twice. Hydrothermal treatment was then carried out under agitation for about 10 hours at about 200° C. This was followed by cooling to 30° C. over the course of 3 hours, then the slurry was dried at 80° C. under continuous stirring to evaporate the solvent. The resulting compound thus obtained was LiFePO₄(OH).

The as-prepared compound was mixed in water with 15 wt. % β-lactose (sold by Sigma-Aldrich) to prepare a uniform slurry, followed by drying at 80° C. for 3 hours.

In an airtight container with a gas inlet and outlet, the as-prepared compound/β-lactose mixture in a ceramic crucible was heated up to 700° C. and maintained at that temperature for about two hours. The airtight container was maintained under flushing with dry nitrogen (100 ml/mn) throughout the duration of the heat treatment. After cooling, the end-compound, carbon deposited LiFePO₄, was obtained in the form of a black powder (the end-compound was named LMP-4).

### Example 3

### Synthesis of C—LiFePO₄

An identical experiment as the one described in Example 2 was repeated, except for adding 1 mole of ascorbic acid per mole of LiOH during the nanomilling step and an additional 1 mole of ascorbic acid per mole of LiOH to the nanomilled slurry prior to the hydrothermal treatment. The resulting compound thus obtained was LiFePO₄ and subsequently, the end-compound thus obtained was C—LiFePO₄ (the end-compound was named LMP-5).

### Example 4

### Synthesis of C—LiFePO₄

The LiFePO₄(OH) obtained in example 2 after the hydrothermal treatment was nanomilled in water with 15 wt. % β-lactose (sold by Sigma-Aldrich) with a continuous-flow agitator bead mill (MicroCer, sold by Netzsch) in order to obtain a LiFePO₄(OH) slurry having nanoscale particles having a size in the order of about 100-150 nm.

The slurry was then spray-dried to obtain secondary micronscale spherical particles having a size in the order of about 20 μm. In an airtight container with a gas inlet and outlet, the as-prepared spray-dried mixture in a ceramic crucible was heated up to 700° C. and maintained at that temperature for about two hours. The airtight container was maintained under flushing with dry nitrogen (100 ml/mn) throughout the duration of the heat treatment. After cooling, the end-compound, carbon deposited LiFePO₄ was obtained in the form of secondary micronscale spherical particles having a size in the order of about 20 μm (the end-compound was named LMP-6).

### Example 5

### Synthesis of C—LiFePO₄

The LiFePO₄ obtained in example 3 after the hydrothermal treatment was nanomilled in water with 15 wt. % β-lactose (sold by Sigma-Aldrich) with a continuous-flow agitator bead mill (MicroCer, sold by Netzsch) in order to obtain a LiFePO₄(OH) slurry having nanoscale particles having a size in the order of about 50-100 nm.

The slurry was then spray-dried to obtain secondary micronscale spherical particles having a size in the order of about 15 μm. In an airtight container with a gas inlet and outlet, the as-prepared spray-dried mixture in a ceramic crucible was heated up to 700° C. and then maintained at that temperature for about two hours. The airtight container was maintained under flushing with dry nitrogen (100 ml/mn) throughout the duration of the heat treatment. After cooling, the end-compound, carbon deposited LiFePO₄, was obtained in the form of secondary micronscale spherical particles having a size in the order of about 15 μm (the end-compound was named LMP-7).

### Example 6

### Synthesis of C—Li(Fe,Mn)PO₄

LiOH.H₂O (sold by Rockwood Lithium), H₃PO₄ (85 wt. % in H₂O, sold by Sigma-Aldrich), micron-sized Fe₂O₃ (5 μm, sold by Sigma-Aldrich), MnO (sold by Sigma-Aldrich) and ascorbic acid, with a 1:1:0.15:0.7:0.25 molar ratio, were nanomilled in water with a continuous-flow agitator bead mill (MicroCer, sold by Netzsch) in order to obtain a nanomilled slurry having nanoscale particles. The nanomilled slurry was then placed in a high pressure reactor (Series 4540, sold by Parr Instrument Company) containing water. 6-7 bar of nitrogen was applied to the autoclave via the immersion pipe and then this pressure was relieved again via the relief valve. The procedure was repeated twice. Hydrothermal treatment was then carried out under agitation for about 10 hours at about 200° C. This was followed by cooling to 30° C. over the course of 3 hours. The resulting compound thus obtained was a LiMn_{0.7}Fe_{0.3}PO₄ slurry.

The slurry was then nanomilled in water with 15 wt. % β-lactose (sold by Sigma-Aldrich) with a continuous-flow agitator bead mill (MicroCer, sold by Netzsch) in order to obtain a nanomilled LiMn_{0.7}Fe_{0.3}PO₄ slurry having particles having a size in the order of about 50 nm.

The nanomilled slurry was then spray-dried to obtain secondary mincronscale spherical particles having a size in the order of about 13 μm. In an airtight container with a gas inlet and outlet, the as-prepared spray-dried mixture in a ceramic crucible was heated up to 700° C. and maintained at that temperature for about two hours. The airtight container was maintained under flushing with dry nitrogen (100 ml/mn) throughout the duration of the heat treatment. After cooling, the end-compound, carbon deposited LiMn_{0.7}Fe_{0.3}PO₄, was obtained in the form of secondary micronscale spherical particles having a size in the order of about 13 μm (the end-compound was named LMP-8).

### Example 7

### Synthesis of C—LiFePO₄

LiOH.H₂O (sold by Rockwood Lithium), H₃PO₄ (85 wt. % in H₂O, sold by Sigma-Aldrich), micron-sized Fe₂O₃ (5 μm, sold by Sigma-Aldrich), Fe (fine powder, sold by Sigma-Aldrich), with a 1:1:0.25:0.5 molar ratio, were nanomilled in water with a continuous-flow agitator bead mill (MicroCer, sold by Netzsch) in order to obtain a nanomilled slurry having nanoscale particles. The nanomilled slurry was then placed in a high pressure reactor (Series 4540, sold by Parr Instrument Company) containing water. 6-7 bar of nitrogen was applied to the autoclave via the immersion pipe and then this pressure was relieved again via the relief valve. The procedure was repeated twice. Hydrothermal treatment was then carried out under agitation for about 10 hours at about 200° C. This was followed by cooling to 30° C. over the course of 3 hours. The resulting compound thus obtained was a LiFePO₄ slurry.

The slurry was then nanomilled in water with 15 wt. % β-lactose (sold by Sigma-Aldrich) with a continuous-flow agitator bead mill (MicroCer, sold by Netzsch) in order to obtain a LiFePO₄ slurry having particles having a size in the order of about 100 nm.

The nanomilled slurry was then spray-dried to obtain secondary micronscale spherical particles having a size in the order of about 20 μm. In an airtight container with a gas inlet and outlet, the as-prepared spray-dried mixture in a ceramic crucible was heated up to 700° C. and maintained at that temperature for about two hours. The airtight container was maintained under flushing with dry nitrogen (100 ml/mn) throughout the duration of the heat treatment. After cooling, the end-product, carbon deposited LiFePO₄, was obtained in the form of secondary micronscale spherical particles having a size in the order of about 20 μm (the end-compound was named LMP-9).

An identical experiment was repeated, except for replacing micron-sized Fe₂O₃ with micron-sized Fe₃O₄, thus with a LiOH/H₃PO₄/Fe₃O₄/Fe reactant at a 1:1:2/9:1/3 molar ratio. The resulting compound thus obtained was LiFePO₄ and subsequently, the end-compound thus obtained was C—LiFePO₄ (the end-compound was named LMP-10).

### Example 8

### Preparation of Liquid Electrolyte Batteries

Liquid electrolyte batteries were prepared according to the following procedure.

Several dispersions were prepared as follows, where in each case, one of the end-compounds described herein, HFP-VF₂ copolymer (Kynar® HSV 900, supplied by Atochem) and an EBN-1010 graphite powder (supplied by Superior Graphite) were carefully mixed in N-methylpyrrolidone for about one hour using zirconia beads in a Turbula® mixer in order to obtain a dispersion composed of a mixture of the end-compound/PVdF-HFP/graphite in a 80/10/10 by weight ratio. The mixture was subsequently deposited, using a Gardner® device, on a sheet of carbon-coated aluminum foil (supplied by Exopack Advanced Coating) and was then dried under vacuum at 80° C. for 24 hours and then stored in a glovebox.

Batteries of the “button” type were thus assembled and sealed in a glovebox, using a carbon-coated aluminum foil carrying the coating comprising one of the herein described end-compound as the battery cathode, a film of lithium as the anode, and a separator having a thickness of 25 μm (supplied by Celgard) impregnated with a 1M solution of LiPF₆ in an EC/DEC 3/7 mixture.

The batteries were subjected to scanning cyclic voltammetry at ambient temperature with a rate of 20 mV/80 s using a VMP2 multichannel potentiostat (Biologic Science Instruments), first in oxydation from the rest potential up to Vₘₐₓ and then in reduction between Vₘₐₓ and Vₘᵢₙ. Voltammetry was repeated a second time and nominal capacity of the cathode material (in mAh/g) determined from the second reduction cycle. Nominal capacities obtained for the different batteries are provided in the following table:

| Battery cathode | Vₘᵢₙ | Vₘₐₓ | C (mAh/g) |
|---|---|---|---|
| LMP-1 | 2.2 | 3.7 | 53 |
| LMP-2 | 2.2 | 3.7 | 137 |
| LMP-3 | 2.2 | 4.4 | 139 |
| LMP-4 | 2.2 | 3.7 | 140 |
| LMP-5 | 2.2 | 3.7 | 138 |
| LMP-6 | 2.2 | 3.7 | 153 |
| LMP-7 | 2.2 | 3.7 | 154 |
| LMP-8 | 2.2 | 4.5 | 149 |
| LMP-9 | 2.2 | 3.7 | 152 |

Clearly the battery comprising the end-compounds LMP2 to LMP9 demonstrated unexpected and surprising electrochemical performances relative to the battery comprising the end-compound LMP1. The herein described process therefore clearly provides unexpected and surprising results.

Similar batteries were also tested, at ambient temperature and at 60° C., with intensiostatic discharge (C/12) between Vₘₐₓ and Vₘᵢₙ V to evaluate cycling capability. After 50 cycles, batteries comprising the end-compound LMP-4, LMP-6, LMP-7, LMP-8 and LMP-9 presented a capacity above 90% of their initial capacities.

The advantageous effect of the herein described invention was also implemented to make other carbon-deposited alkali metal oxyanion including, but without any limitation, C—LiFe_{0.65}Mn_{0.3}Mg_{0.05}PO₄, C—LiMn_{0.675}Fe_{0.275}Mg_{0.05}PO₄, C—Li_{0.9}Na_{0.1}FePO₄, C—NaFePO₄, C—LiFe_{0.95}Zr_{0.5}(PO₄)_{0.95}(SiO₄)_{0.05} and C—LiFe_{0.95}Mg_{0.05}PO₄.

### Example 9

### Synthesis and Characterization of C—LiFePO₄

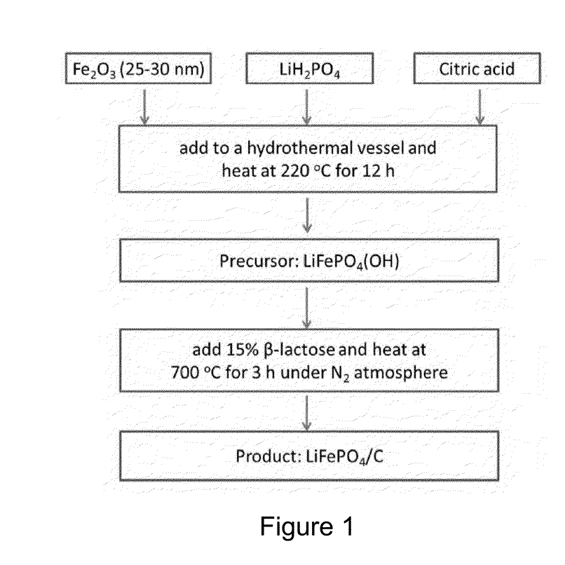

In this Example, commercially-available nanopartiuclate ferric oxide (Fe₂O₃) was used with LiH₂PO₄ as precursors in a modified hydrothermal method to prepare carbon-coated LiFePO₄ nanoparticles (C—LiFePO₄) in two steps, following the general method of FIG. 1. In the first step, LiFePO₄(OH) was made hydrothermally using citric acid as a chelating agent. In the second step, β-lactose and the LiFePO₄(OH) particles were then combined and heated at high temperature under N₂ atmosphere to form carbon-coated LiFePO₄. The present inventors have determined that the single-step reduction of LiFePO₄(OH) to LiFePO₄ and concomitant carbon coating improves the crystallinity and the conductivity, and thus the electrochemical performance of the carbon-coated LiFePO₄ nanoparticles.

First, a hydrothermal method was used to make LiFePO₄(OH). Stoichiometric amounts of LiH₂PO₄, Fe₂O₃ (25-30 nm particle size, Sigma-Aldrich) and citric acid in a molar ratio of 1:0.5:1 together with 10-20 wt % water as solvent, were added to a 40 mL Teflon liner, purged with N₂ under sonication, and the disposed in a stainless steel autoclave. The autoclave was put into an isothermal oven and maintained at 220° C. for 12 h, after which the material was allowed to cool naturally to room temperature. The resulting slurry was dried at 80° C. under continuous stirring to evaporate the solvent to yield LiFePO₄(OH). For sake of comparison, a second batch of LiFePO₄(OH) was prepared by the same hydrothermal process in the absence of citric acid.

In the second step, C—LiFePO₄ was prepared from each batch of LiFePO₄(OH) via heat treatment. For each batch, β-lactose (Sigma-Aldrich) in an amount of 15:100 by weight with respect to the LiFePO₄(OH) was dissolved in distilled water and mixed with the LiFePO₄(OH) to form a uniform slurry. The slurry was dried at 80° C. for 3 h under vigorous stirring to remove excess water, then calcined at 700° C. for 3 h in a tube furnace under N₂ atmosphere to yield the C—LiFePO₄.

The LiFePO₄(OH) and C—LiFePO₄ so prepared were characterized using a variety of conventional techniques. X-ray diffraction (XRD) was performed using a Bruker D8 X-ray Advance diffractometer equipped with a Cu Kα (k=1.5405 Å) as radiation source. Phase purity was determined by comparison with the standard data (JCPDS card). The particle size and morphology of samples were examined by a Scanning Electron Microscope (Hitachi S-4300 microscope). A Fisons Instruments (SPA, model EA1108) elemental analyzer was used to determine the carbon content in samples.

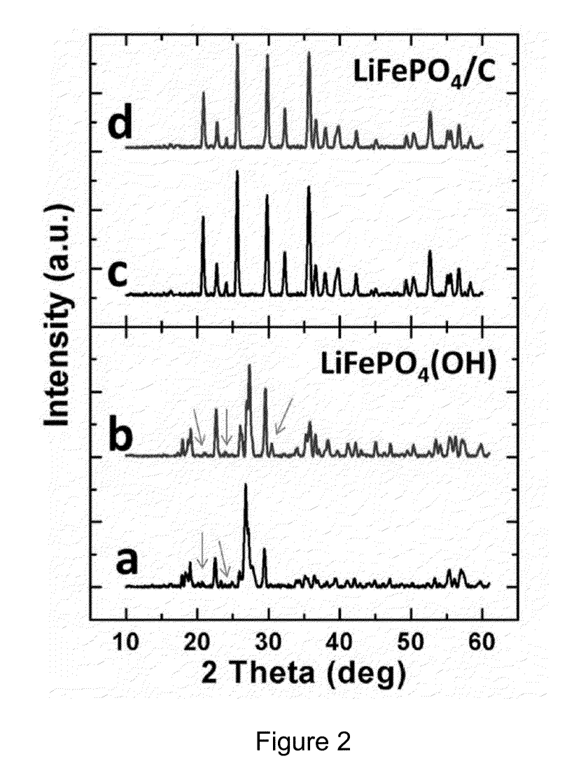

FIGS. 2(a) and 2(b) respectively provide the XRD patterns of the LiFePO₄(OH) synthesized with and without citric acid by a hydrothermal method. The peaks can be indexed with respect to a triclinic crystal system using the P-I space group, except for several minor unknown small peaks indicated by the arrows. The color of the LiFePO₄(OH) prepared with citric acid is green, while the LiFePO₄(OH) prepared without citric acid is yellow. The green color implies that there exists a small amount of Fe(II) compound. However, no LiFePO₄ or other Fe(II) compound were detected in LiFePO₄(OH) synthesized with citric acid as seen from the XRD patterns. While not intending to be bound to theory, Applicants surmise that the Fe(II) species are amorphous, or are present as only very small crystallites.

Particle size data for the LiFePO₄(OH) samples are provided in Table 1.

TABLE 1

| | | C—LiFePO₄ | LiFePO₄(OH) | C—LiFePO₄ |
|---|---|---|---|---|
| | LiFePO₄(OH) | with | without citric | without |
| Sample | with citric acid | citric acid | acid | citric acid |
| Crystal | 28.8 | 33.0 | 29.6 | 33.4 |
| size (nm) | | | | |
| Color | Green | Black | Yellow | Black |

There is no significant difference in crystallite size (as calculated by the Scherrer formula) of the LiFePO₄(OH) between the material made using citric acid and the material made without citric acid. Here, the solid Fe₂O₃ precursor had a nanoscale particle size (25-30 nm); the particle size of products was not significantly affected by the presence of chelating agent or surfactant. This is in contrast with the situation for solution precursors, where for a desirably small particle size. it is necessary that a chelating agent or surfactant be added to control the nucleation and Ostwald ripening processes.

FIGS. 2(c) and 2(d) provide the XRD patterns of the C—LiFePO₄ prepared with the LiFePO₄(OH) precursors (i.e., respectively prepared with and without citric acid). After heat treatment at 700° C. under N₂ atmosphere, both as-prepared LiFePO₄(OH) materials were transformed into C—LiFePO₄. As is evident from the XRD patterns, the C—LiFePO₄ composite materials had good crystallinity and were formed without undesirable impurity phases such as Fe₂O₃ and Li₃Fe₂(PO₄)₃ which often exist in LiFePO₄ products prepared by conventional solid state methods. The XRD patterns of FIGS. 2(c) and 2(d) do not exhibit any apparent diffraction peak resulting from carbon. Accordingly, the inventors surmise that the carbon exists in the form of amorphous or low crystalline carbon in these samples.

In this Example, the calcination temperature of 700° C. was selected to balance two aspects of the calcination step: too high a temperature can lead to an undesirable increase in particle size and agglomeration, while too low a temperature may not be sufficient for the carbonization of β-lactose and crystallization of LiFePO₄. In the experiments described herein, post heat treatment was performed for only 3 h under N₂, which may reduce the cost and prevent the growth of grain size.

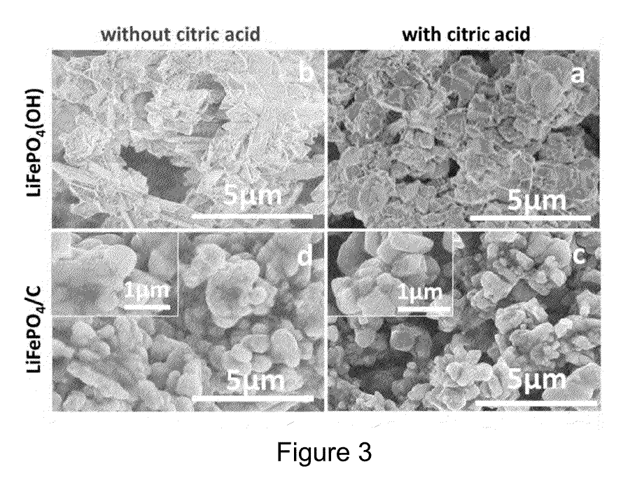

Another advantage of certain methods and materials described herein is exemplified by this Example. Without intending to be bound by theory, the inventors surmise that the in situ formed carbon can provide a network structure to impede the grain growth of the LiFePO₄. As shown in Table 1, the grain size does not increase upon heat treatment at 700° C. FIGS. 3(a)-(d) provide SEM images of as-synthesized LiFePO₄(OH) (a, b) and the corresponding C—LiFePO₄ (c, d). As shown in FIG. 3(a), LiFePO₄(OH) synthesized by the hydrothermal method with citric acid exhibited a uniform particle size distribution with an average particle size of ˜0.7 μm. In contrast, for LiFePO₄(OH) synthesized by the hydrothermal method without citric acid, there is an agglomeration of particles and a larger particle size distribution ranging from nanoscale to microscale, as shown in FIG. 3(b). As described above with respect to the XRD results, the crystallite size is substantially the same for materials made with and without citric acid; this is confirmed by the SEM images. However, the use of citric acid helps to provide homogeneous particle distribution. While not intending to be bound by theory, the inventors surmise that this is because the chelating of citric acid with iron oxide can prevent the aggregation of iron oxide and LiFePO₄(OH) crystallites. The morphology of the C—LiFePO₄ synthesized from the LiFePO₄(OH) precursors is shown in FIGS. 3(c) and 3(d). As seen from the SEM images, there is no apparent change in particle size after the heat treatment at 700° C. as a result of the in situ carbon coating, which is in agreement with the XRD results. In addition, the C—LiFePO₄ prepared with citric acid exhibits a more uniform particle size distribution than that prepared without citric acid, as seen from the insets in FIGS. 3(c) and 3(d). Moreover, the smooth outer surface of LiFePO₄ implies the carbon coating on the LiFePO₄. The carbon content in both C—LiFePO₄ samples was 3.7 wt % as measured by elemental analysis, indicating that the carbon content predominantly results from the pyrolysis of β-lactose.

The materials were evaluated electrochemically by combining 80 wt % C—LiFePO₄ powder, 10 wt % of conductive carbon (Super-P Li, Timcal) and 10 wt % poly(vinylidene difluoride) (PVDF, 5% in N-methylpyrroldinone (NMP)) with an excess of NMP to form slurry. The slurry was then deposited on a carbon coated Al foil. After drying at 90° C. overnight, electrode disks were punched and weighed for the cell assembly in standard 2032 coin-cell hardware (Hohsen) using a lithium metal foil as both counter and reference electrodes and a Celgard 2200 separator. Cells were assembled in an argon-filled glove box using 1 M LiPF₆ in ethylene carbonate/diethyl carbonate (2:1 by volume) as an electrolyte (UBE). Battery performance evaluations were performed by charging and discharging between 2.2 and 4.0 V with a current rate of 0.1 C at 30° C. using a BT-2000 electrochemical station (Arbin).

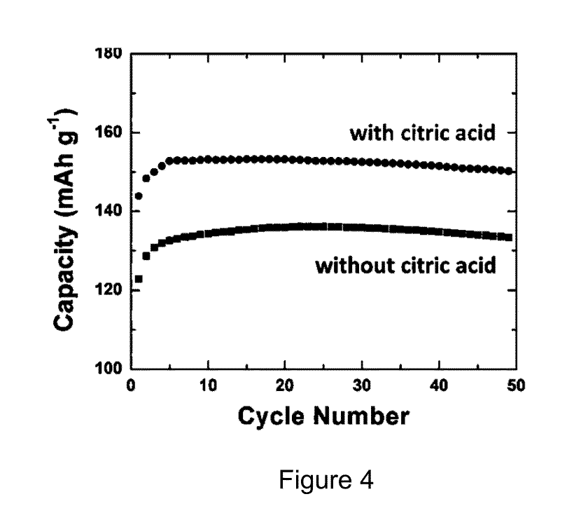

The electrochemical properties of the C—LiFePO₄ samples synthesized with and without citric acid are shown in FIG. 4. While both samples provide acceptable performance, C—LiFePO₄ produced without citric acid has a lower specific discharge capacity (˜130 mA/g at 0.1 C) than the C—LiFePO₄ produced with citric acid (˜153 mAh/g at 0.1 C. Without intending to be bound by theory, the inventors surmise that this is due to its larger particle size distribution. The ˜153 mAh/g discharge capacity of the C—LiFePO₄ prepared with citric acid maintains 98% after 50 cycles. Without intending to be bound by theory, the inventors attribute this to the high purity, small particle size, uniform particle size distribution and good crystallinity of in-situ formed C—LiFePO₄ material.

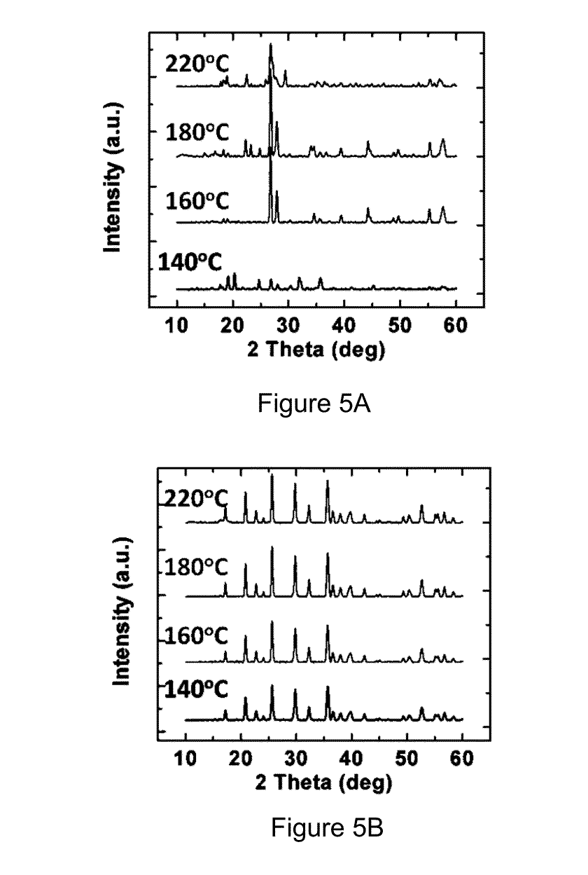

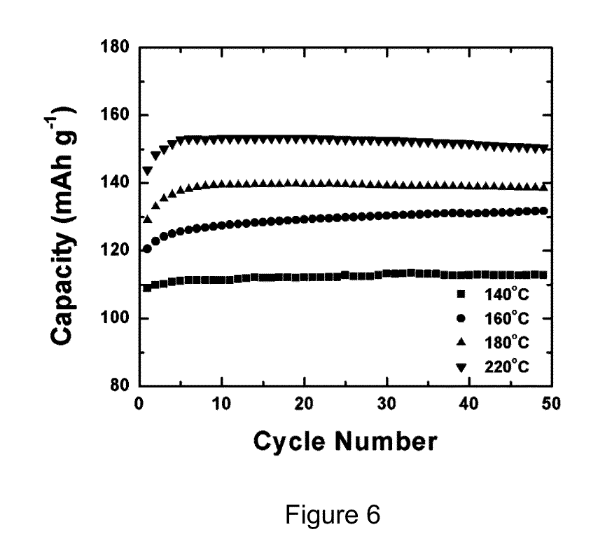

To make clear the effect of the hydrothermal process to the performance of C—LiFePO₄, additional syntheses were performed (with citric acid) using a variety temperatures (140° C., 160° C., 180° C., 220° C.) in the hydrothermal reaction step (i.e., in formation of the LiFePO₄(OH). FIGS. 5A and 5B are a set of XRD spectra of the resulting LiFePO4(OH) and C—LiFePO4 materials. As shown in FIG. 5A, when the temperature is 180° C. and lower, a complex mixture of products is formed in the hydrothermal reaction. Upon addition of β-lactose and calcination as described above, each of these precursors is transformed to C—LiFePO₄, as shown in FIG. 5B. All of the C—LiFePO₄ materials thus obtained are pure and well crystallized. The electrochemical performance of the obtained C—LiFePO₄ is shown in FIG. 6. Notably, the discharge capacity increases with increasing hydrothermal temperature.

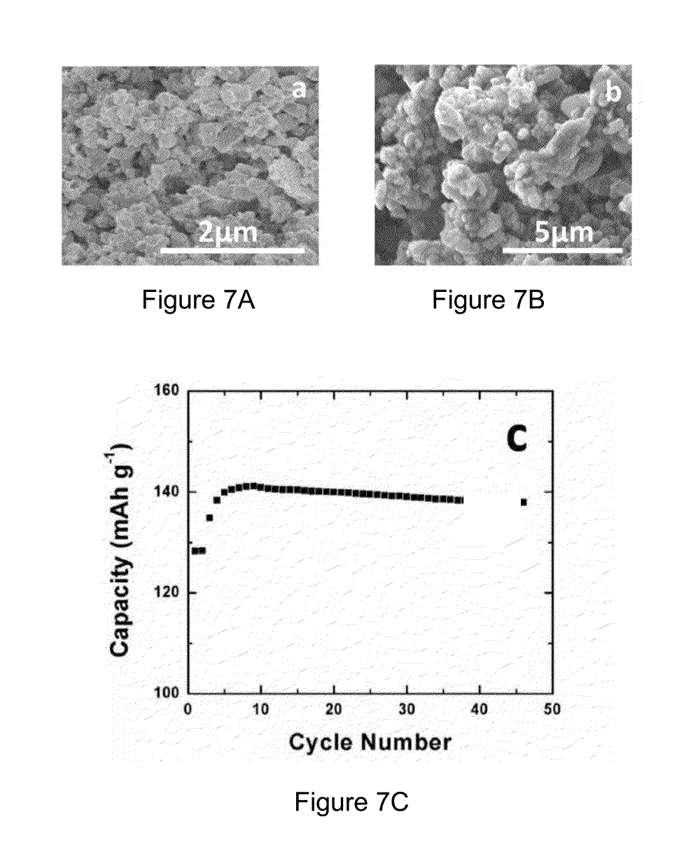

The above-described preparations of this Example used commercially-available nanoparticulate Fe₂O₃ as a precursor. In order to further reduce cost for large scale synthesis, commercial micron-sized Fe₂O₃ powder (˜5 μm) was milled with a planetary machine to provide nanoscale Fe₂O₃, which was used as a precursor to prepare C—LiFePO₄ under the same conditions as in the first-described preparation of this Example. FIG. 7A shows the SEM images of the milled Fe₂O₃. It has a particle size of about 200 nm and uniform size distribution. FIG. 7B shows the morphology of C—LiFePO₄ prepared with the milled Fe₂O₃; the morphology is similar to that shown in FIG. 3(a). As shown in FIG. 7C, the specific discharge capacity of the as-prepared C—LiFePO₄ about ca. 140 mAh/g. These results demonstrate that hydrothermal synthesis of LiFePO₄(OH) using low iron oxide precursors, followed by reduction and carbon coating via calcination is attractive for the large scale synthesis of LiFePO₄/C for lithium ion batteries.

### Example 10

### Synthesis and Characterization of LiFePO₄

In this Example, LiFePO₄ was prepared via a one-step hydrothermal method using nanoscale Fe₂O₃ as a precursor. In a first preparation, LiH₂PO₄, Fe₂O₃ (25-30 nm, Sigma-Aldrich Co. LLC) and ascorbic acid in a molar ratio of 1:0.5:0.5 were put into a 40 mL Teflon-lined stainless steel autoclave and maintained at 230° C. for 48 h. The mixture was allowed to cool to room temperature, then the water in the hydrothermal product was evaporated at 80° C. to provide the LiFePO₄ product.

In a second preparation, H₃PO₃ was used as the reducing agent. LiH₂PO₄, Fe₂O₃ (25-30 nm, Sigma-Aldrich Co. LLC) and H₃PO₃ in a molar ratio of 1:0.5:0.5 were put into a 40 mL Teflon-lined stainless steel autoclave and maintained at 230° C. for 48 h. The mixture was allowed to cool to room temperature, then the water in the hydrothermal product was evaporated at 80° C. to provide the LiFePO₄ product.

In a third preparation, H₃PO₃ was used as a co-reducing agent together with ascorbic acid. LiOH, H₃PO₃, H₃PO₄, Fe₂O₃ (25-30 nm) and ascorbic acid in a molar ratio of 1:0.5:0.5:0.5:0.5. were put into a 40 mL Teflon-lined stainless steel autoclave and maintained at 230° C. for 48 h. The mixture was allowed to cool to room temperature, then the water in the hydrothermal product was evaporated at 80° C. to provide the LiFePO₄ product.

In this Example, X-ray diffraction (XRD) was performed using a Bruker D8 X-ray Advance diffractometer equipped with a Cu Kα (k=1.5405 Å) as radiation source. Phase purity was checked by comparison with the standard data (JCPDS card). The particle size and morphology of samples were examined by a Scanning Electron Microscope (Hitachi S-4300 microscope). A Fisons Instruments (SPA, model EA1108) elemental analyzer was used to determine the carbon content in samples. X-ray photoelectron spectroscopy (XPS) was performed with a Scanning Auger Multi Probe PHI Spectrometer (Model 25-120) equipped with Al source operating at 250 W. The signal was filtered with a hemispherical analyzer (pass energy=100 eV for survey spectra and 25 eV for fine spectra). The C(1 s) photoelectron line at 284.6 eV was used as an internal standard for the correction of the charging effect in all samples.

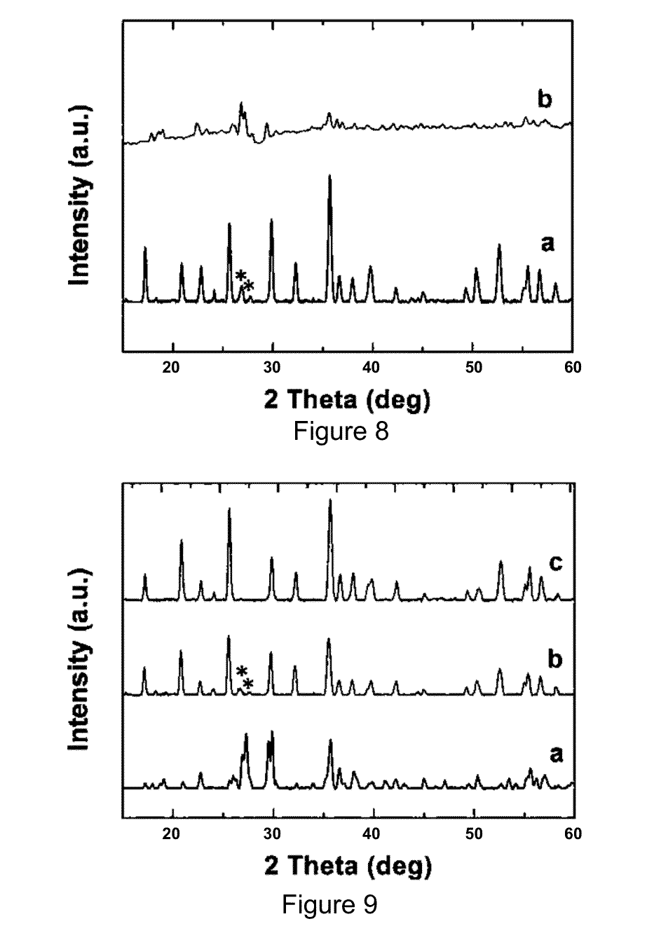

FIG. 8(a) shows the XRD pattern of the product of the first preparation of this Example (i.e., using ascorbic acid as a reducing agent). The main phase of the product can be identified as LiFePO₄ with an ordered orthorhombic crystal structure (JCPDS #40-11499, space group: pmnb). Two impurity peaks appear in FIG. 8(a), each marked with an asterisk; both are indexed as Fe₃(PO₄)₂(OH)₃, demonstrating that a minor amount of Fe(III) remains in the material.

Under the hydrothermal reaction conditions, ascorbic acid is pyrolyzed to carbonaceous material, and a reductive atmosphere (CO and/or H₂) is formed. To determine whether the reductive atmosphere or the carbon powder is active in the reduction of Fe(III) to Fe(II), the ascorbic acid was replaced with carbon in a third preparation of this Example. As demonstrated by the XRD pattern of the product in FIG. 8(b), no LiFePO₄ is formed. Accordingly, without intending to be bound by theory, the inventors surmise that it is the reductive atmosphere that is active in reducing Fe(III) to Fe(II). Moreover, while the ascorbic acid is pyrolyzed, the inventors believe that the resulting carbonaceous material is not generally sufficient for use as a carbon coating. Accordingly, it can be desirable to perform carbon coating via another step (e.g., calcination with a reducing sugar, or by further reaction of the carbonaceous material derived from the ascorbic acid).

FIG. 9(a) shows the XRD pattern of the product prepared with H₃PO₃ alone as the reducing agent (i.e., according to the second preparation of this example). The crystalline part of the product is a mixture of LiFePO₄(OH) and LiFePO₄, indicating that the H₃PO₃ only incompletely reduced the Fe(III) to Fe(II). FIG. 9(b) shows the XRD pattern of a product prepared with ascorbic acid alone as the reducing agent; as described above with respect to FIG. 8(a), Fe(III) impurity remains in the product. As noted above, in thie third preparation according to this Example both ascorbic acid and H₃PO₃ were used as reducing agents. The XRD pattern of the resulting product is provided in FIG. 9(c). Here, the XRD pattern exhibits no Fe(III) impurity, indicating that Fe(III) can be completely reduced to Fe(II) by the combination of ascorbic acid and H₃PO₃ in a single-step hydrothermal method. Without intending to be bound by theory, the inventors also surmise that the H₃PO₃ may change pH of the reaction mixture, which may also help remove the impurity. Accordingly, while the hydrothermal process can be performed at relatively low temperature, one or more of high pressure conditions (i.e., sealed high pressure reactor) and a combination of reducing agents can provide pure C—LiFePO₄ with good crystallinity, as shown in FIG. 9(c).

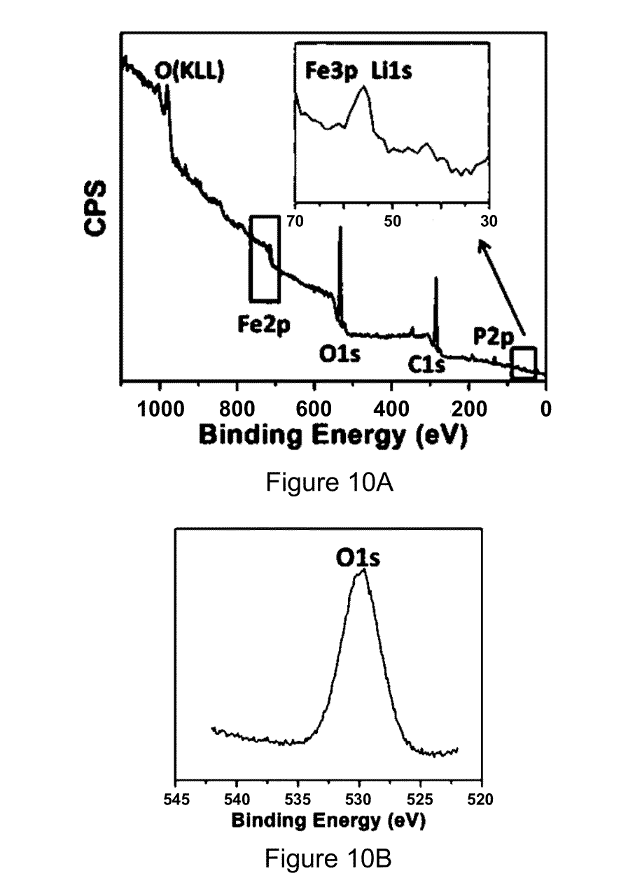

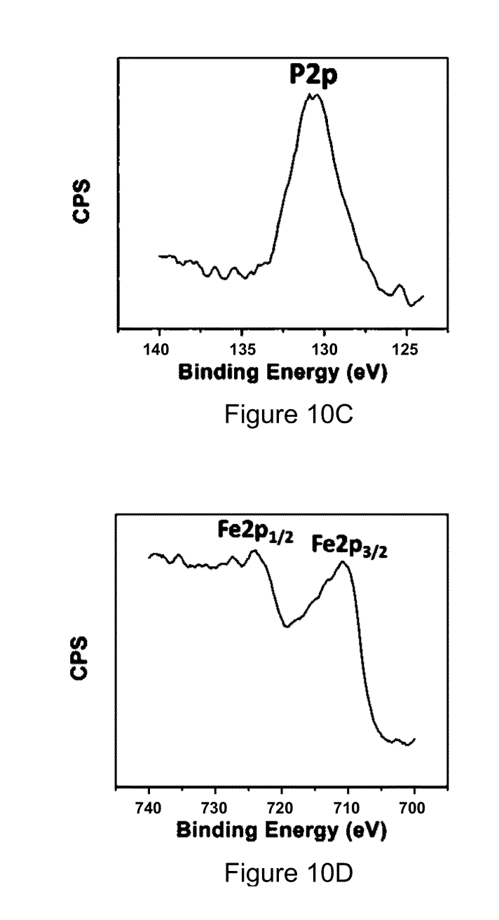

XPS analysis was used to investigate the chemical compositions and valence states of the as-synthesized C—LiFePO4 (i.e., as prepared with both ascorbic acid and H₃PO₃). As shown in the XPS survey spectrum of FIG. 10A, the sample consists of the elements Fe, P, O, C and Li. Li1s overlaps with Fe3p as seen from the inset of FIG. 10(a). As shown in FIGS. 10B and 10C, both O1s and P2p have a symmetrical shape and well-defined features. Their XPS peaks are located at 530.1 eV and 130.7 eV, respectively, which is due to the phosphate moiety. The Fe2p spectrum (FIG. 10D) exhibits a doublet at 724.0 eV for Fe2p1/2 and at 710.9 eV for Fe2p3/2, which is typical of Fe(II). The signal from Fe2P was not found in this spectrum. Accordingly, the XPS analysis confirms the purity of LiFePO₄.

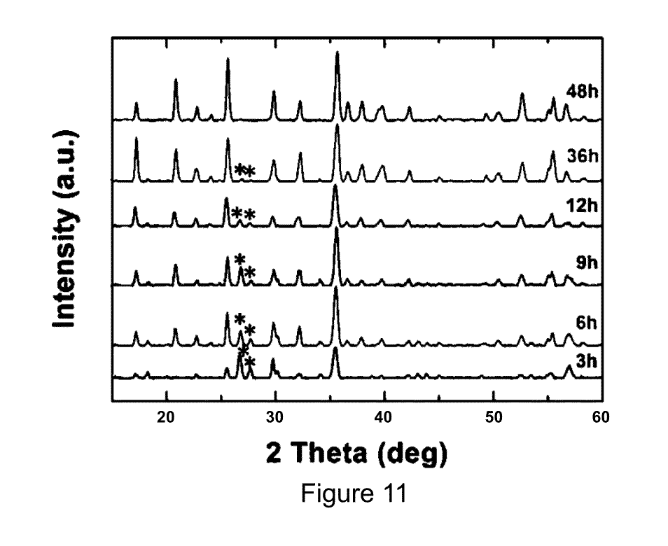

To further study the reaction mechanism, the hydrothermal reaction was performed at 230° C. (using the reaction mixture of the second preparation of this Example) for various times (3 h, 9 h, 12 h, 36 h and 48 h). FIG. 11 shows the XRD patterns for the respective LiFePO₄ samples. At 3 h, as FIG. 11 shows, the main phase of the product can be indexed as LiFePO₄ except for two small peaks which are attributed to Fe₃(PO₄)₂(OH)₃. Notably, the crystallinity of the product is low since the reaction time is short. With increasing the reaction time from 6 h to 36 h, the peaks from the impurity become gradually weaker, while the peaks from LiFePO₄ phase become narrower and stronger, indicating that the crystallinity and purity of LiFePO₄ is greatly improved as the reaction time increases.

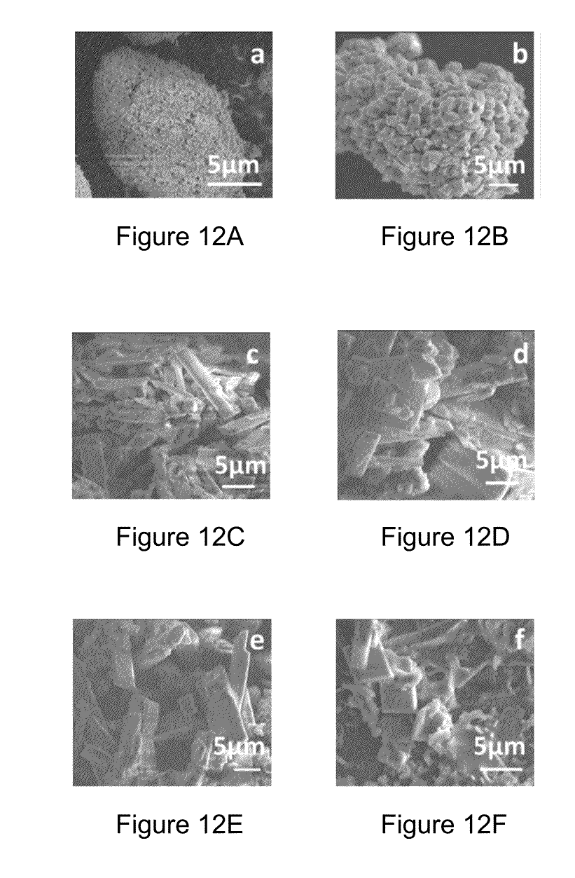

FIG. 12 shows a series of typical morphologies from precursor to LiFePO₄ product. FIG. 12A provides an SEM image of the commercial 25-30 nm Fe₂O₃ precursor. Hydrothermal reaction for 3 h yields 2-3 μm particles, which are uniform and dispersed very well as shown in FIG. 12B. However, after 12 h, the microparticles evolve to microtubes, which are irregular and poorly dispersed (FIG. 12C). The microtubes continue to grow after 24 h (FIG. 12D) and 36 h (FIG. 12E), and finally agglomerate as LiFePO₄ after 48 h (FIG. 12F). Three mechanisms are possible in the crystal formation and growth process under hydrothermal conditions: precipitation from supersaturated solution, in situ transformation and dissolution-precipitation. Without intending to be bound by theory, the inventors, based on the morphological observations by SEM in FIG. 12 and phase transformation of products in FIG. 11, assume an in-situ transformation mechanism: the nano Fe₂O₃ precursor provides initial nucleation sites where other dissolved precursors diffuse around it and react with it to produce mixture of LiFePO₄ and little impurity under the reducing atmosphere. In contrast to the dissolution-precipitation mechanism, an in situ transformation mechanism requires a much longer time because the ions need to slowly diffuse through the undissolved solid compound. That is why the impurity exists at the beginning of reaction. Over time, the slow diffusion of ions towards solid cores leads to the gradual penetration of the reaction into solid cores, which leads to the growth and agglomeration of solid particles. Meanwhile, the impurities are gradually reacted and finally completely consumed under the reducing atmosphere to provide pure LiFePO₄.

### Example 11

### Synthesis and Characterization of C—LiMn_{0.7}Fe_{0.3}PO₄

In this Example, pure LiMn_{0.7}Fe_{0.3}PO₄ was prepared via a hydrothermal method using low cost, commercially-available Fe₂O₃ and MnO as precursors. Stoichiometric amounts of LiH₂PO₄, Fe₂O₃, MnO (Sigma-Aldrich Co. LLC) and ascorbic acid with a mole ratio of 1:0.15:0.7:0.25 were milled for 3 h in about 10-20 wt % water by a planetary milling in a 250 mL Syalon container with 25 mm zirconia balls. The resulting suspension was transferred to a 110 mL Teflon-lined stainless steel autoclave. The same amount of ascorbic acid as in the milling process was also added to the autoclave. After bubbling N₂ for 30 min, the autoclave was sealed and maintained at 230° C. for 24 h.

In this Example, X-ray diffraction (XRD) was performed using a Bruker D8 X-ray Advance diffractometer equipped with a Cu Kα (k=1.5405 Å) as radiation source. Phase purity was determined by comparison with the standard data (JCPDS card). The particle size and morphology of samples were examined by a Scanning Electron Microscope (Hitachi S-4300 microscope). A Fisons Instruments (SPA, model EA1108) elemental analyzer was used to determine the carbon content in samples.

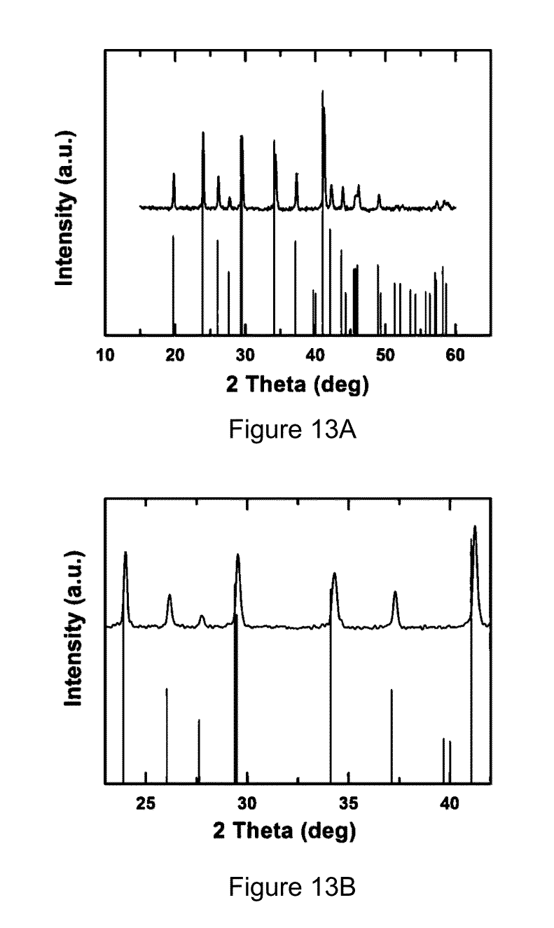

The X-ray diffraction (XRD) patterns of as-prepared LiMn_{0.7}Fe_{0.3}PO₄ are shown in FIG. 13A. All the diffraction peaks are clearly indexed as olivine-type LiMPO₄ (M=Mn, Fe) which belongs to the Pnma space group of the orthorhombic crystal system. This is in agreement with the reported values (JCPDS card no.74-0375) except the slight shift of XRD peaks. Fe²⁺ and Mn²⁺ ions are located at the tetrahedral 4c sites in LiMnₓFe₁₋ₓPO₄. Since the tetrahedrally coordinated Mn²⁺ has a larger ionic radius (0.97 Å) than Fe²⁺ (0.92 Å), the lattice expansion occurs and the lattice parameters increase with substitution of Fe²⁺ by Mn²⁺ in the theoretical LiFePO₄ structure. While not intending to be bound by theory, the inventors believe that this explains why the diffraction peaks have a slight shift as shown in FIG. 13A. As a result, the as-prepared LiFe_{0.7}Mn_{0.3}PO₄ is a solid solution of LiFePO₄ and LiMnPO₄, with no impurity phase detected in the scanning range. FIG. 13B is an expanded view of FIG. 13A in the range of 25 to 40° to clearly demonstrate the displacement of the diffraction peaks with the incorporation of Fe into the crystal lattice. The average crystallite size of LiFe_{0.7}Mn_{0.3}PO₄, was calculated as 508 nm according to the Scherrer formula. FIG. 14 provides SEM images of the as-prepared LiMn_{0.7}Fe_{0.3}PO₄. As shown in FIG. 14A, the product has a uniform particle distribution but a particle size of 1-2 μm.

The resulting LiMn_{0.7}Fe_{0.3}PO₄ powder was milled in a continuous-flow agitator bead mill (MicroCer by Netszch) for 2 h, until a uniform particle size distribution (particle size ˜100 nm) was achieved. β-Lactose (Fisher) (10 wt % with respect to the active materials) was added into the milling slurry during the last 15 minutes of milling. The slurry was collected from the mill and the water was then evaporated from the milled slurry. The material was then carbon coated by heating at 700° C. for 3 h under nitrogen atmosphere. In order to improve electrochemical performance, the as-prepared LiMn_{0.7}Fe_{0.3}PO₄ was milled to get fine particles and then coated with a film of carbon to improve its conductivity. As seen from FIG. 14B, the particle size is reduced to 50-100 nm after milling and a film of carbon was coated on the particles. Carbon coated LiMn_{0.7}Fe_{0.3}PO₄ powders were composed of individual particles with a small degree of particle agglomeration. Chemical analysis indicates that the carbon content in the carbon coated LiMn_{0.7}Fe_{0.3}PO₄ is 7.42 wt %.

Electrochemical evaluations were performed by combining 80 wt % C—LiMn_{0.7}Fe_{0.3}PO₄, 10 wt % of conductive carbon (Super-P Li, Timcal) and 10 wt % polyvinylidene difluoride (5% in N-methylpyrroldinone (NMP)) with an excess of NMP to form slurry, which was deposited on a carbon coated Al foil. After drying at 90° C. overnight, electrode disks were punched and weighed for the cell assembly in standard 2032 coin-cell hardware (Hohsen) using a lithium metal foil as both counter and reference electrodes and a Celgard 2200 separator. Cells were assembled in an argon-filled glove box using 1 M LiPF₆ in ethylene carbonate (EC)/diethyl carbonate (DEC) (2:1 by volume) as an electrolyte (UBE). Battery performance evaluations were performed by charging and discharging between 2.2 and 4.5 V with a current rate of 0.01 C at 30° C. using a BT-2000 electrochemical station (Arbin).

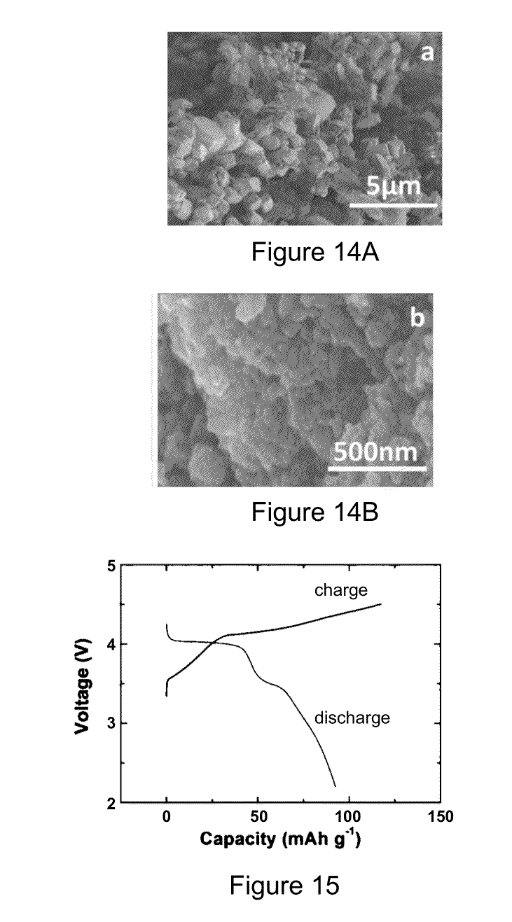

FIG. 15 presents the initial charge-discharge curve of the C—LiMn_{0.7}Fe_{0.3}PO₄. The cells at 30° C. were charged to 4.5 V in a constant current mode at a rate of C/100 (where 1 C=170 mAh/g), followed by a discharge to 2.2 V at the same rate. The as-prepared C—LiMn_{0.7}Fe_{0.3}PO₄ exhibits two reversible charge-discharge plateaus. The one at ˜4.1 V vs. Li/Li⁺ corresponds to the Mn³⁺/Mn²⁺ redox couple, while the other at ˜3.5 V vs. Li/Li⁺ corresponds to the Fe³⁺/Fe²⁺ redox couple. The presence of both obvious plateaus indicates that the charge/discharge reaction proceeds via first-order phase transitions. The redox process of Fe³⁺/Fe²⁺ takes place at a higher potential in LiFeₓMn₁₋ₓPO₄ than that in pure LiFePO₄, which means that LiFeₓMn₁₋ₓPO₄ is expected to have a higher energy density than pure LiFePO₄. The initial specific discharge capacity for C—LiFe_{0.3}Mn_{0.7}PO₄ is 100 mAh/g. As the person of ordinary skill in the art will appreciate, the electrochemical performance of olivine structures depends on several factors: crystallinity, morphology, particle size, homogeneity, specific surface area and electrode kinetics. Here, the as-prepared C—LiFe_{0.3}Mn_{0.7}PO₄ has a lower discharge capacity. The XRD and SEM data demonstrate that the product has a high purity and a small particle size; thus these are not likely the cause of the lower electrochemical performance. But chemical analysis indicated that the carbon content in the C—LiFe_{0.3}Mn_{0.7}PO₄ prepared in this example is as high as 7.42 wt %. This is higher than the 2-3 wt % that is often considered to be optimal for the electrochemical performance of cathode materials; without intending to be bound by theory, the inventors surmise that this increased carbon content is one of causes leading to the reduced performance of the as-prepared material. Moreover, low-temperature routes can lead to Mn²⁺ disorder on the Li+ sites in LiMnPO₄ (anti-site defects), which blocks the one-dimensional (1 D) diffusion path of Li ions, thus limiting electrochemical activity. Another possible cause is the low electronic conductivity of olivine-structure materials. Again, while not intending to be bound by theory, the inventors surmise that these additional factors may have impacted the electrochemical performance of this sample.

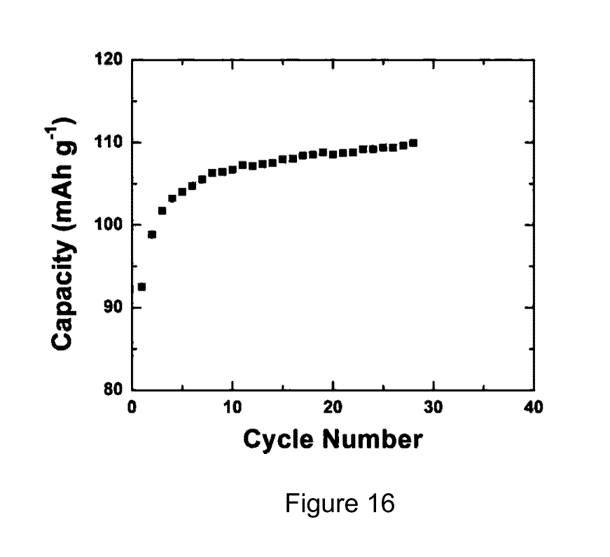

FIG. 16 shows the cyclic stability of as-prepared C—LiMn_{0.7}Fe_{0.3}PO₄. Interestingly, the discharge capacity of the sample in this experiment increases gradually with cycle number, although the initial discharge capacity is lower. Without intending to be bound by theory, the inventors surmise that this is likely due to the partial agglomeration of nano particles during carbon coating at 700° C. Consequently, not all the surface of an individual particle is exposed to the electrolyte. Upon repeated charge-discharge cycling, the particles de-agglomerate, exposing more surfaces to the electrolyte and increasing capacity from the initial value. Again, without intending to be bound by theory, another possible explanation for the capacity improvement upon cycling in olivine/carbon composites could be due to the improved penetration of the electrolyte into the interiors of the particles as a result of the formation of cracks in the amorphous carbon layer.

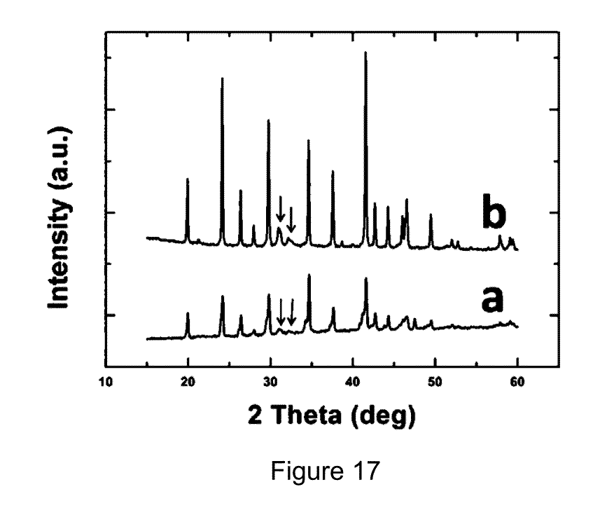

The MnO and Fe₂O₃ starting materials used in this Example are micro-scale. The inventors have determined that it can be advantageous to mill such materials to provide precursors with smaller particle size and homogenous distribution for the hydrothermal reactions. Moreover, without intending to be bound by theory, the milling process can increase the free energy of the system, and thus enhance the reactivity and activity of raw materials to favor complete hydrothermal reaction. To demonstrate the effect of use of nanoscale precursors (e.g., by milling microscale precursors before reaction), the preparation of this Example was repeated under the same conditions without prior milling of the microscale precursors. FIG. 17(a) shows the XRD patterns of the as-prepared product, with arrows indicating the impurity phases.

Ascorbic acid is often used as a reducing agent to prevent the oxidation of Fe(II) to Fe(III) during the hydrothermal reaction in the synthesis of LiFePO₄. In the preparation of this Example, ascorbic acid is employed not only in the hydrothermal treatment but also in the pre-milling process. In the pre-milling process, ascorbic acid was used to prevent the oxidation of Mn(II) and the aggregation of particles. The red color of the slurry after the whole pre-milling process implies that Fe(III) was not reduced in the milling process. As a result of the high energy in the milling process, the inventors surmise that ascorbic acid might lose some of its effectiveness. Accordingly, in this preparation, an additional same amount of ascorbic acid was added during the hydrothermal treatment to reduce Fe(III) to Fe(II). To confirm this assumption, in a separate preparation, ascorbic acid was added only in the pre-milling process. All other conditions were kept the same. FIG. 17(b) shows the XRD pattern of the as-prepared product. As the arrows show in FIG. 17(b), the product includes impurities. Accordingly, without intending to be bound by theory, the inventors surmise that the initially-added acid was consumed in the high-energy pre-milling step, and thus that it can be desirable to add fresh ascorbic acid before the hydrothermal treatment to effectively reduce Fe(III) to Fe(II) to provide pure product. Of course, in other embodiments, the person of ordinary skill in the art can address decomposition of ascorbic acid during milling, for example, by adding higher amounts of ascorbic acid to the mixture to be milled, or by adding an additional reducing agent to the mixture to be milled.

### Comparative Example 2

### Solid State Synthesis of C—LiFePO₄

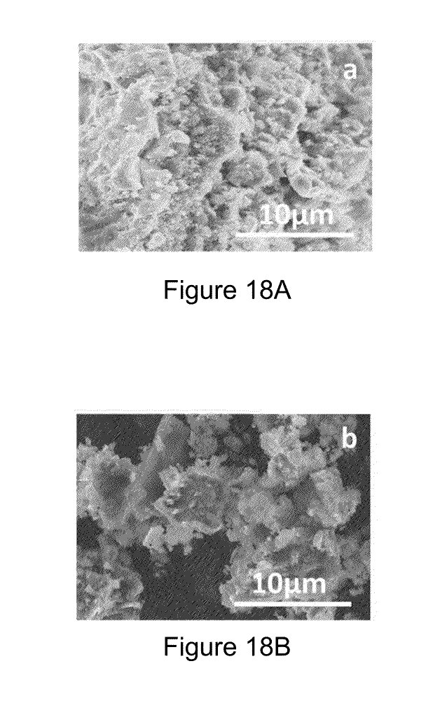

As a comparative example, C—LiFePO₄ was prepared using a solid state synthesis method with the same iron, lithium and phosphate precursors described above in Example 9 and carbon. Two heat treatment times of 3 h and 10 h were employed to compare with the results of Example 9 and to ensure the completeness of reaction, respectively. Both products contain a small amount of impurity evident from the XRD patterns (not shown here) and the particles aggregate to bulk due to high temperature calcination as evident from the SEM images in FIGS. 18A (3 h) and 18B (10 h). This agglomeration is not favorable for the diffusion of lithium ions due to the longer pathway for migration and thus leads to the poor performance (not shown here). This embodies the advantages of certain aspects of the present invention: the hydrothermal reaction in the first step can bring the products with small particle size and uniform particle size distribution, while the subsequent heat treatment induces high crystallinity and the complete reduction from Fe(III) to Fe(II).

Although the present invention has been described in considerable detail with reference to certain embodiments thereof, variations and refinements are possible without departing from the spirit of the invention. While the compositions and methods of this invention have been described in terms of preferred embodiments, it will be apparent to those of skill in the art that variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

All references cited throughout the specification are hereby incorporated by reference in their entirety.

1. A process for manufacturing an alkali metal oxyanion, wherein said metal comprises Fe, said process comprising the steps of:
providing a source of Fe having nanoscale particle size; and
hydrothermally treating said source of Fe and precursors of an at least partially lithiated metal oxyanion for manufacturing said alkali metal oxyanion.

2. A process according to claim 1, wherein said precursors are provided prior to the hydrothermal step.

3. A process according to claim 1, wherein said source of Fe comprises Fe³⁺.

4. A process according to claim 1, wherein the precursor is selected to provide an alkali metal oxyanion of the general nominal formula AₐMₘ(XO₄)ₓZ_{z} in which:
A is an alkali metal selected from lithium, sodium, potassium and any combinations thereof, and 0<a≦8;
M comprise at least 50% at. of Fe, or Mn, or a mixture thereof, and 1≦m≦3; and
XO₄ is an oxyanion in which X is selected from P, S, V, Si, Nb, Mo and any combinations thereof; and 0<x≦3; and
Z is an hydroxide; and 0≦z≦3, and
wherein A, M, X, a, m, x and z are selected as to maintain electroneutrality of said compound.

5. A process according to claim 4, wherein the precursor is selected to provide an alkali metal oxyanion of the general nominal formula LiM(XO₄)Z_{z} in which:
M comprise at least 80% at. of Fe, or Mn, or a mixture thereof; and
XO₄ is an oxyanion in which X is selected from P, S, Si and any combinations thereof; and
Z is an hydroxide; and 0≦z≦1, and
wherein M, X and z are selected as to maintain electroneutrality of said compound.

6. A process according to claim 1, wherein said process further comprises a pyrolysis step of an organic carbon source to produce a pyrolytic carbon deposit on particles of said alkali metal oxyanion.

7. A process according to claim 1, wherein a reducing agent is added during the hydrothermal step.

8. A process according to claim 7, wherein said reducing agent comprises ascorbic, citric acid, or a mixture thereof.

9. A process according to claim 7, wherein said reducing agent comprises metallic iron.

10. A process according to claim 1, further comprising a grinding step after said hydrothermal step.

11. A process according to claim 10, wherein said grinding step is a nanomilling step.

12. A process according to claim 1, wherein said source of iron is selected from Fe₂O₃, Fe₃O₄, FeOOH, Fe(OH)₃ and any mixtures thereof.

13. A process according to claim 1, the Fe source of nanoscale particle size is provided by wet nanomilling a Fe source of larger particle size.

14. A process according to claim 13, wherein a reducing agent is added during the wet-nanomilling step.

15. A process according to claim 14, wherein said reducing agent comprises ascorbic, citric acid, or a mixture thereof.

16. A process according to claim 14, wherein said reducing agent comprises metallic iron.

17. A process for manufacturing an alkali metal oxyanion having the nominal formula LiMnₓFe₁₋ₓPO₄ in which 0≦x≦0.8, and the process comprises:
providing a source of Fe having nanoscale particle size, and, optionally, a source of Mn having nanoscale particle size; and
subjecting the source of Fe and, if provided, the source of Mn to hydrothermal treatment with lithium phosphate, lithium hydrogen phosphate, lithium dihydrogen phosphate, or lithium hydroxide in combination with phosphoric acid, or a mixture thereof, under conditions sufficient to form LiMnₓFe₁₋ₓPO₄(OH); and
reducing the LiMnₓFe₁₋ₓPO₄(OH) to form LiMnₓFe₁₋ₓPO₄.

18. A process according to claim 17, wherein the source of Fe is Fe₂O₃ and the source of Mn is MnO, and wherein the reduction is performed by calcination with a reducing sugar.

19. A process for manufacturing an alkali metal oxyanion having the nominal formula LiMnₓFe₁₋ₓPO₄ in which 0≦x≦0.8, and the process comprises:
providing a source of Fe having nanoscale size, and, optionally, a source of Mn having nanoscale size; and
subjecting the source of Fe and, if provided, the source of Mn to hydrothermal treatment with lithium phosphate, lithium hydrogen phosphate, lithium dihydrogen phosphate or a mixture thereof and one or more reducing agents, under conditions sufficient to form LiMnₓFe₁₋ₓPO₄.

20. The process according to claim 19, wherein the source of Fe is Fe₂O₃ and the source of Mn is MnO, and wherein reducing agent is ascorbic acid, H₃PO₃, or a combination thereof.
